(19) United States
(12) Patent Application Publication
(10) Pub. No.: US 2025/0225752 A1
(43) Pub. Date: Jul. 10, 2025

(54) BLOOD AND SALIVA HANDLING FOR INTRAORAL SCANNING

(71) Applicant: Align Technology, Inc., San Jose, CA (US)

(72) Inventors: Sagi Schein, Kiryat Tivon (IL); Sergey Turko, Moscow (RU); Maxim Volgin, Moscow (RU); Pavel Agniashvili, Moscow (RU); Uriel Barron, Tel Aviv (IL)

(21) Appl. No.: 19/014,066

(22) Filed: Jan. 8, 2025

Related U.S. Application Data
(60) Provisional application No. 63/619,295, filed on Jan. 9, 2024.

(51) Int. Cl. G06T 19/20; A61C 9/00; G06T 7/00; G06T 7/11; G06V 10/764; G06V 20/64; G06V 20/70

(52) U.S. Cl. CPC G06T 19/20; A61C 9/006; G06T 7/0012; G06T 7/11; G06T 2207/10028; G06T 2207/20081; G06T 2207/20084; G06T 2207/30036; G06T 2210/41; G06T 2219/2021; G06V 10/764; G06V 20/647; G06V 20/70

(57) ABSTRACT

In a method of processing intraoral scan data includes receiving intraoral scan data comprising one or more intraoral images of a portion of a dental site generated using structured light projection during intraoral scanning of the dental site, generating a three-dimensional (3D) point cloud of the portion of the dental site using the intraoral scan data, detecting one or more regions of the 3D point cloud comprising a bodily fluid, removing the one or more regions from the 3D point cloud, updating a 3D surface of the dental site using the 3D point cloud of the portion of the dental site, and outputting the 3D surface of the dental site to a display.

### RELATED APPLICATIONS

This application claims benefit of U.S. Provisional Application No. 63/619,295, filed Jan. 9, 2024, the contents of which are incorporated by reference herein in their entirety.

### TECHNICAL FIELD

Embodiments of the present disclosure relate to the field of intraoral scanning and, in particular, to a system and method for performing detection, correction and/or notification with regards to blood and saliva in intraoral scans and/or three-dimensional (3D) models generated from intraoral scans.

### BACKGROUND

In prosthodontic procedures designed to insert a dental prosthesis in the oral cavity, the dental site at which the prosthesis is to be implanted in many cases should be measured accurately and studied carefully, so that a prosthesis such as a crown, denture or bridge, for example, can be properly designed and dimensioned to fit in place. A good fit enables mechanical stresses to be properly transmitted between the prosthesis and the jaw, and to prevent infection of the gums via the interface between the prosthesis and the dental site, for example.

Some procedures also call for removable prosthetics to be fabricated to replace one or more missing teeth, such as a partial or full denture, in which case the surface contours of the areas where the teeth are missing need to be reproduced accurately so that the resulting prosthetic fits over the edentulous region with even pressure on the soft tissues.

In some practices, the dental site is prepared by a dental practitioner, and a positive physical model of the dental site is constructed using known methods. Alternatively, the dental site may be scanned to provide 3D data of the dental site (i.e. in the form of intraoral images such as height maps). In either case, the virtual or real model of the dental site is sent to the dental lab, which manufactures the prosthesis based on the model. However, if the model is deficient or undefined in certain areas, or if the preparation was not optimally configured for receiving the prosthesis, the design of the prosthesis may be less than optimal. For example, if the insertion path implied by the preparation for a closely-fitting coping would result in the prosthesis colliding with adjacent teeth, the coping geometry has to be altered to avoid the collision, which may result in the coping design being less optimal. Further, if the area of the preparation containing a finish line lacks definition, it may not be possible to properly determine the finish line and thus the lower edge of the coping may not be properly designed. Indeed, in some circumstances, the model is rejected and the dental practitioner then re-scans the dental site, or reworks the preparation, so that a suitable prosthesis may be produced.

In orthodontic procedures it can be important to provide a model of one or both jaws. Where such orthodontic procedures are designed virtually, a virtual model of the oral cavity is also beneficial. Such a virtual model may be obtained by scanning the oral cavity directly, or by producing a physical model of the dentition, and then scanning the model with a suitable scanner.

Thus, in both prosthodontic and orthodontic procedures, obtaining a three-dimensional (3D) model of a dental site in the oral cavity is an initial procedure that is performed. When the 3D model is a virtual model, the more complete and accurate the scans of the dental site are, the higher the quality of the virtual model, and thus the greater the ability to design an optimal prosthesis or orthodontic treatment appliance(s).

During an intraoral scanning session, often blood and/or saliva pools within a patient's mouth. Such blood and/or saliva alters the optical properties of a scanned surface, which changes a captured shape of a dental site (e.g., introduces deformations to a surface of the dental site) and reduce an accuracy of the generated virtual model.

### SUMMARY

In a first aspect of the disclosure, a method comprises receiving scan data comprising an intraoral image during an intraoral scan of a dental site, identifying a representation of a foreign object in the intraoral image based on an analysis of the scan data, modifying the intraoral image by removing the representation of the foreign object from the intraoral image, receiving additional scan data comprising a plurality of additional intraoral images of the dental site during the intraoral scan, and generating a virtual three-dimensional (3D) model of the dental site using the modified intraoral image and the plurality of additional intraoral images.

In a second aspect of the disclosure, an intraoral scanning system comprises: an intraoral scanner configured to generate intraoral scan data; and a computing device configured to: receive intraoral scan data comprising one or more intraoral images of a portion of a dental site generated using structured light projection during intraoral scanning of the dental site; generate a three-dimensional (3D) point cloud of the portion of the dental site using the intraoral scan data; detect one or more regions of the 3D point cloud comprising a bodily fluid; remove the one or more regions from the 3D point cloud; update a 3D surface of the dental site using the 3D point cloud of the portion of the dental site; and output the 3D surface of the dental site to a display.

In a third aspect of the disclosure, an intraoral scanning system comprises: an intraoral scanner configured to generate intraoral scan data; a first computing device configured to: receive intraoral scan data comprising one or more intraoral images of a portion of a dental site generated using structured light projection during intraoral scanning of the dental site; generate a three-dimensional (3D) point cloud of the portion of the dental site using the intraoral scan data; and transmit the 3D point cloud to a second computing device; and the second computing device, configured to: detect one or more regions of the 3D point cloud comprising a bodily fluid; remove the one or more regions from the 3D point cloud; update a 3D surface of the dental site using the 3D point cloud of the portion of the dental site; and transmit the 3D surface of the dental site to the first computing device.

In a fourth aspect of the disclosure, an intraoral scanner comprises: a plurality of structured light projectors to generate a structured light pattern; a plurality of cameras to capture a plurality of images of a portion of a dental site illuminated by the structured light pattern; and a processor configured to: generate a three-dimensional (3D) point cloud of the portion of the dental site using at least some of the plurality of images; detect one or more regions of the 3D point cloud comprising a bodily fluid; remove the one or more regions from the 3D point cloud; and transmit the 3D point cloud to a computing device for further processing.

### BRIEF DESCRIPTION OF THE DRAWINGS

The present disclosure is illustrated by way of example, and not by way of limitation, in the figures of the accompanying drawings.

FIG. 1 illustrates one embodiment of a system for performing intraoral scanning and generating a virtual three dimensional model of a dental site.

FIG. 2A is a schematic illustration of a handheld intraoral scanner with a plurality cameras disposed within a probe at a distal end of the intraoral scanner, in accordance with some applications of the present disclosure.

FIGS. 2B-2C comprise schematic illustrations of positioning configurations for cameras and structured light projectors of an intraoral scanner, in accordance with some applications of the present disclosure.

FIG. 2D is a chart depicting a plurality of different configurations for the position of structured light projectors and cameras in a probe of an intraoral scanner, in accordance with some applications of the present disclosure.

FIG. 2E is a flow chart outlining a method for generating a digital three-dimensional image, in accordance with some applications of the present disclosure.

FIG. 2F is a flowchart outlining a method for carrying out a specific step in the method of FIG. 2E, in accordance with some applications of the present disclosure.

FIGS. 2G-J are schematic illustrations depicting a simplified example of the steps of FIG. 2F, in accordance with some applications of the present disclosure.

FIG. 3 illustrates a view of a graphical user interface of an intraoral scan application that includes a 3D surface and a combined 2D image of a current field of view of an intraoral scanner showing pooled blood, in accordance with embodiments of the present disclosure.

FIG. 4 illustrates a flow diagram for a method of identifying and removing representations of bodily fluids in intraoral scan data, in accordance with embodiments of the present disclosure.

FIG. 5 illustrates a flow diagram for a method of identifying and removing representations of bodily fluids in intraoral scan data, in accordance with embodiments of the present disclosure.

FIG. 6 illustrates a flow diagram for a method of addressing bodily fluids in intraoral scan data, in accordance with embodiments of the present disclosure.

FIG. 7 illustrates a flow diagram for a method of identifying bodily fluids in intraoral scan data, in accordance with embodiments of the present disclosure.

FIG. 8A illustrates a model training workflow for training one or more machine learning models to identify bodily fluids and/or other dental object classifications in intraoral scan data, in accordance with an embodiment of the present disclosure.

FIG. 8B illustrates a model application workflow for using one or more machine learning models to identify bodily fluids and/or other dental object classifications in intraoral scan data, in accordance with an embodiment of the present disclosure.

FIG. 9 illustrates a block diagram of an example computing device, in accordance with embodiments of the present disclosure.

### DETAILED DESCRIPTION

Described herein is a method and apparatus for identifying bodily fluids such as blood and/or saliva in intraoral scan data, and in improving the quality of intraoral scans taken of dental sites that include one or more pooled bodily fluids. Techniques described herein may be used to detect and prevent geometric deformations in intraoral scans and/or three-dimensional (3D) models generated from intraoral scans due to bodily fluids, such as blood, saliva bubbles, and so on. During intraoral scanning, bodily fluids may build up and pool in a patient's mouth. Opaque bodily fluids such as blood may obscure the shape of an underlying surface of a dental site covered by the opaque bodily fluids, reducing an accuracy of captured intraoral scan data of the dental site. Similarly, transparent bodily fluids such as saliva may also obscure or distort the shape of an underlying surface of a dental site covered by the transparent bodily fluids, again reducing an accuracy of captured intraoral scan data of the dental site. Saliva may be particularly difficult to detect and correct for due to the transparent or semi-transparent nature of saliva.

Bodily fluids may build up at a dental site, and intraoral scans and/or images may capture the bodily fluids. These fluids may refract light (e.g., such as structured light) and induce crater-like deformations in a reconstructed 3D model of a dental site. The inclusion of such bodily fluids in intraoral scans and/or images can also slow down processing of those intraoral scans and/or images and reduce the accuracy of a virtual 3D model generated from the intraoral scans and/or images. Accordingly, embodiments described herein provide techniques for filtering out (i.e. removing) the depictions of bodily fluids in real-time or near real-time (e.g., as the intraoral scans or images are generated). Such detection and removal of bodily fluids from intraoral scan data may be performed before the regions obscured by the bodily fluids are used for image registration and/or virtual model generation. Alternatively, such detection and removal of bodily fluids may be performed on a 3D model after the 3D model has been generated. By removing the bodily fluids from the intraoral scans or images before performing further processing on those intraoral scans or images, the speed and/or accuracy of the further processing may be increased. For example, the speed of image or scan registration may be increased, the accuracy of image or scan registration may be increased, the number of instances of failures to register scans or images may be decreased, the accuracy of a generated 3D virtual model may be increased, and/or the speed of generating the 3D virtual model may be increased. Additionally, process intensive operations of accounting for and mitigating problems caused by bodily fluids may be omitted, further increasing the speed of image or scan processing. The accuracy of 3D models of dental sites may also be improved by identifying and removing bodily fluids from the 3D models after their generation.

In some embodiments, in addition to, or instead of, removing bodily fluids from captured intraoral scan data (e.g., intraoral scans and/or images) and/or from 3D models generated from such intraoral scan data, an alert or notification is generated to notify a user of the identified bodily fluids and/or suspected bodily fluids. The alert may be generated, for example, if an amount of bodily fluids and/or suspected bodily fluids exceeds a threshold. The alert may include a recommendation for a dental practitioner to remove the bodily fluids (e.g., by wiping or using suction) and/or take other corrective action. Responsive to such an alert, a dental practitioner may pause intraoral scanning and remove the bodily fluids before proceeding with intraoral scanning.

Embodiments may improve the accuracy of 3D models of a patient's dental arches, and may reduce a number of returned jobs. A returned job may occur when a lab or other facility that receives a 3D model of a patient's dental arches determines that a quality of the 3D models is too low to use for generation of dental appliances (e.g., such as orthodontic aligners, palatal expanders, caps, crowns, bridges, etc.) and notifies a dental practitioner to repeat an intraoral scan of the patient's dental arches to generate improved 3D models of those dental arches.

Some embodiments focus on the detection and prevention of geometric deformations due to saliva bubbles and blood. In some embodiments, an active intraoral scanner shines structured light on scanned surfaces and triangulates the location of geometric deformations. When structured light passes through fluids such as saliva and blood, reflections and refractions may alter and optical path of the structured light and cause geometrical deformations in a resultant 3D model. Intraoral scanners that use structured light projection may be particularly vulnerable to inaccuracies caused by bodily fluids due to the fact that structured light projectors and cameras that capture images of the reflected light on intraoral surfaces are typically at angles to one another. In contrast, intraoral scanners that use confocal optics for determining depth may have light projectors and cameras that parallel to an imaging axis, reducing a sensitivity to geometrical distortions caused by bodily fluids (e.g., saliva bubbles, pooled blood, pooled saliva, etc.).

Embodiments identify bodily fluids in intraoral scan data (e.g., point clouds generated from intraoral scan data) during scanning, and enable depictions of the bodily fluids to be removed during such scanning. This enables a dental practitioner to see which areas have been affected by buildup of bodily fluids such as blood and/or saliva, and to address such areas and then continue scanning with the bodily fluid removed. One advantage of this approach is that it reduces the confusion dentists may have with respect to handling saliva and/or blood. Since in many cases the impact of saliva and/or blood induced deformation only becomes apparent at a later stage (e.g., after scanning is complete and a 3D model has been generated) the approach described herein may also save dentist time during scanning by calling attention to areas in which there is too much blood and/or saliva.

In some embodiments, a sequence of operations is performed to identify bodily fluids in intraoral scan data, and to remove representations of such bodily fluids from the intraoral scan data. In one example solution usable for identifying bodily fluids in intraoral scan data generated using structured light projection, a first operation detects suspected saliva pixels in 2D images or 3D images (e.g., color 2D images) of a dental site generated by an intraoral scanner. The images may include a set of color images each generated by a different camera of an intraoral scanner at a same time (or at about a same time). A machine learning model such as a neural network may have been trained from a large set of labeled images to solve a binary image segmentation problem, where each pixel of an input image may be assigned a probability score which estimates the probability of that pixel being a bodily fluid pixel. The probability scores may be captured in a segmentation mask or probability mask for each image. In embodiments, the amount of suspected bodily fluid pixels may be compared to one or more thresholds, and an alert may be generated if the amount of suspected bodily fluid pixels exceeds the one or more thresholds.

In a second operation, structured light points or features from images of the dental site captured using structured light projection may be projected on the generated segmentation mask or masks. Each of the images may be generated by one of the multiple cameras of the intraoral scanner, and may correspond to one of the color images generated by the same camera. The field of view of the multiple cameras may overlap. Accordingly, each structured light point may be viewed by multiple cameras. Each structured light point may be a 3D point generated by solving a correspondence algorithm for points or features captured in the multiple images.

In embodiments, a combined score (e.g., an average score) may be computed per 3D point. The combined score may be a combined probability of the 3D point being a bodily fluid point. Use of the combined score for identification of bodily fluids may improve bodily fluid detection stability. In embodiments, a thresholding operation may be performed to determine for each of the 3D points whether that a point is bodily fluid candidate. In some embodiments, each 3D point in a generated point cloud is associated with one or more corresponding pixels in captured images, where each pixel have a determined probability value indicating a probability of that pixel depicting a bodily fluid. In some embodiments, a voting algorithm is used to determine whether a 3D point is a bodily fluid point based on bodily fluid classifications (e.g., probability values) for the pixels associate with the 3D point.

In a third operation, spatial evidence of bodily fluids may be collected, taking into account the fact that saliva bubbles and bodily fluids are typically continuous. Specifically, for each suspected bodily fluid point determined from the second operation, the density of the additional suspected bodily fluid points around or proximate to that suspected bodily fluid point may be computed. A region considered for determining density may be a circular region centered on the suspected bodily fluid point in embodiments. Bodily fluid points in high density regions of bodily fluid points may be confirmed as bodily fluid points in embodiments.

In a fourth operation, for each confirmed bodily fluid point, an inclusion circle may be computed. In embodiments, all points in these inclusion circles are confirm as bodily fluid points. In some embodiments, bodily fluid points may then be excluded from a surface reconstruction operation, which induces holes in these regions of a reconstructed 3D mesh of the dental arch.

Embodiments are described herein that accurately identify and filter out or remove depictions of bodily fluids from intraoral scan data and/or from 3D surfaces generated from intraoral scan data. In particular, embodiments are described that perform particularly well in identifying and removing or filtering out depictions of bodily fluids from intraoral scan data that has been generated using structured light projection. Though embodiments are discussed with reference to identifying and removing regions depicting bodily fluids, the techniques discussed herein with regards to bodily fluids may also apply to other types of dental object classes. For example, the same or similar techniques may be used to identify and remove depictions of foreign objects (e.g., dental tools, hands, fingers, etc.), moving tissue (e.g., tongue, lips, cheeks, etc.), excess tissue, etc. In such instances, machine learning models may be trained to identify one or more other types of dental classes to be removed from intraoral scan data and/or 3D surfaces. Accordingly, though an emphasis is placed on bodily fluids in the following discussion, it should be understood that embodiments also apply to other types of dental object classes.

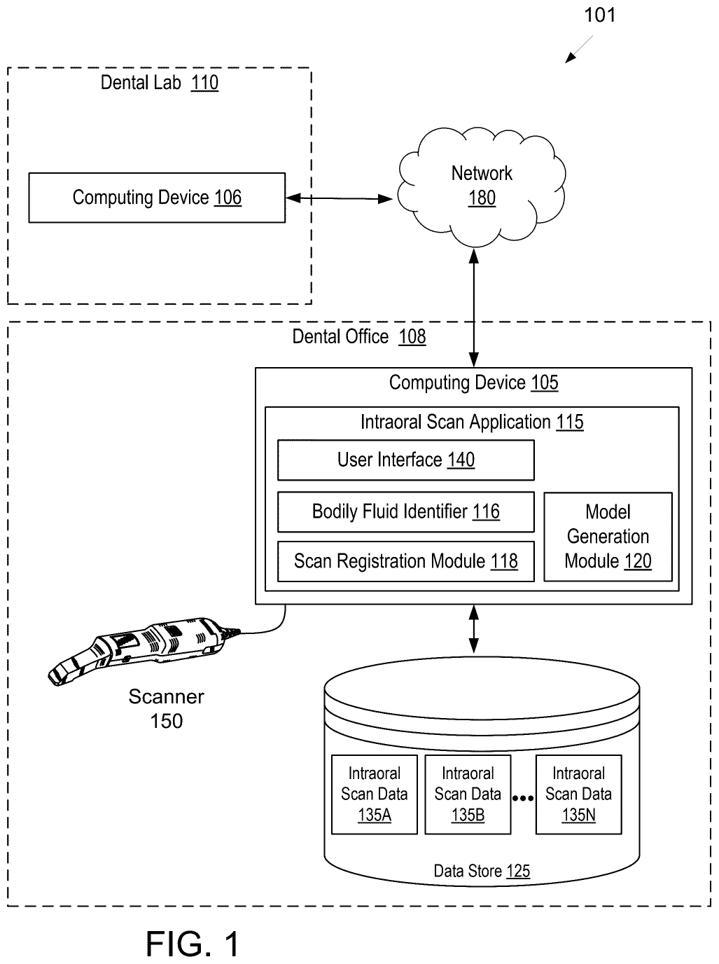

Referring now to the figures, FIG. 1 illustrates one embodiment of a system 101 for performing intraoral scanning and/or generating a three-dimensional (3D) surface and/or a virtual three-dimensional model of a dental site that identifies and filters out depictions of bodily fluids. System 101 includes a dental office 108 and optionally one or more dental lab 110. The dental office 108 and the dental lab 110 each include a computing device 105, 106, where the computing devices 105, 106 may be connected to one another via a network 180. The network 180 may be a local area network (LAN), a public wide area network (WAN) (e.g., the Internet), a private WAN (e.g., an intranet), or a combination thereof.

Computing device 105 may be coupled to one or more intraoral scanner 150 (also referred to as a scanner) and/or a data store 125 via a wired or wireless connection. In one embodiment, multiple scanners 150 in dental office 108 wirelessly connect to computing device 105. In one embodiment, scanner 150 is wirelessly connected to computing device 105 via a direct wireless connection. In one embodiment, scanner 150 is wirelessly connected to computing device 105 via a wireless network. In one embodiment, the wireless network is a Wi-Fi network. In one embodiment, the wireless network is a Bluetooth network, a Zigbee network, or some other wireless network. In one embodiment, the wireless network is a wireless mesh network, examples of which include a Wi-Fi mesh network, a Zigbee mesh network, and so on. In an example, computing device 105 may be physically connected to one or more wireless access points and/or wireless routers (e.g., Wi-Fi access points/routers). Intraoral scanner 150 may include a wireless module such as a Wi-Fi module, and via the wireless module may join the wireless network via the wireless access point/router.

Computing device 106 may also be connected to a data store (not shown). The data stores may be local data stores and/or remote data stores. Computing device 105 and computing device 106 may each include one or more processing devices, memory, secondary storage, one or more input devices (e.g., such as a keyboard, mouse, tablet, touchscreen, microphone, camera, and so on), one or more output devices (e.g., a display, printer, touchscreen, speakers, etc.), and/or other hardware components.

In embodiments, scanner 150 includes an inertial measurement unit (IMU). The IMU may include an accelerometer, a gyroscope, a magnetometer, a pressure sensor and/or other sensor. For example, scanner 150 may include one or more micro-electromechanical system (MEMS) IMU. The IMU may generate inertial measurement data (also referred to as movement data), including acceleration data, rotation data, and so on.

Computing device 105 and/or data store 125 may be located at dental office 108 (as shown), at dental lab 110, or at one or more other locations such as a server farm that provides a cloud computing service. Computing device 105 and/or data store 125 may connect to components that are at a same or a different location from computing device 105 (e.g., components at a second location that is remote from the dental office 108, such as a server farm that provides a cloud computing service). For example, computing device 105 may be connected to a remote server, where some operations of intraoral scan application 115 are performed on computing device 105 and some operations of intraoral scan application 115 are performed on the remote server.

Some additional computing devices may be physically connected to the computing device 105 via a wired connection. Some additional computing devices may be wirelessly connected to computing device 105 via a wireless connection, which may be a direct wireless connection or a wireless connection via a wireless network. In embodiments, one or more additional computing devices may be mobile computing devices such as laptops, notebook computers, tablet computers, mobile phones, portable game consoles, and so on. In embodiments, one or more additional computing devices may be traditionally stationary computing devices, such as desktop computers, set top boxes, game consoles, and so on. The additional computing devices may act as thin clients to the computing device 105. In one embodiment, the additional computing devices access computing device 105 using remote desktop protocol (RDP). In one embodiment, the additional computing devices access computing device 105 using virtual network control (VNC). Some additional computing devices may be passive clients that do not have control over computing device 105 and that receive a visualization of a user interface of intraoral scan application 115. In one embodiment, one or more additional computing devices may operate in a master mode and computing device 105 may operate in a slave mode.

Intraoral scanner 150 may include a wand for optically capturing three-dimensional structures. The intraoral scanner 150 may be used to perform an intraoral scan of a patient's oral cavity. An intraoral scan application 115 running on computing device 105 may communicate with the scanner 150 to effectuate the intraoral scan. A result of the intraoral scan may be intraoral scan data 135A, 135B through 135N that may include one or more sets of intraoral scans or first images (e.g., images generated using structured light projection) and/or sets of second images (e.g., intraoral 2D images). First images and second images may be generated using different lighting conditions. For example, first images may be images generated using structured light projection, and second images may be images generated using unstructured light projection or illumination (e.g., uniform white light illumination). Each intraoral scan may include a 3D image or point cloud that may include depth information (e.g., a height map) of a portion of a dental site. In embodiments, intraoral scans include x, y and z information. In some embodiments, each 3D intraoral scan includes or is based on a set of 2D images each generated by a different camera of the intraoral scanner using structured light projection. Features (e.g., points, spots, checkerboard areas, etc.) from the projected structured light may be captured in the set of 2D images, and a correspondence problem may be solved for one or more of the features to generate a 3D mesh or point cloud.

Intraoral scan data 135A-N may include color 2D images and/or images of particular wavelengths (e.g., near-infrared (NIRI) images, infrared images, ultraviolet images, etc.) of a dental site in embodiments. In embodiments, intraoral scanner 150 alternates between generation of 3D intraoral scans (e.g., using structured light projection) and one or more types of 2D intraoral images (e.g., color images, NIRI images, etc.) during scanning. For example, one or more 2D color images may be generated between generation of a fourth and fifth intraoral scan by outputting white light and capturing reflections of the white light using multiple cameras.

The scanner 150 may transmit the intraoral scan data 135A, 135B through 135N to the computing device 105. Computing device 105 may store the intraoral scan data 135A-135N in data store 125

According to an example, a user (e.g., a practitioner) may subject a patient to intraoral scanning. In doing so, the user may apply scanner 150 to one or more patient intraoral locations. The scanning may be divided into one or more segments (also referred to as roles). As an example, the segments may include a lower dental arch of the patient, an upper dental arch of the patient, one or more preparation teeth of the patient (e.g., teeth of the patient to which a dental device such as a crown or other dental prosthetic will be applied), one or more teeth which are contacts of preparation teeth (e.g., teeth not themselves subject to a dental device but which are located next to one or more such teeth or which interface with one or more such teeth upon mouth closure), and/or patient bite (e.g., scanning performed with closure of the patient's mouth with the scan being directed towards an interface area of the patient's upper and lower teeth). Via such scanner application, the scanner 150 may provide intraoral scan data 135A-N to computing device 105. The intraoral scan data 135A-N may be provided in the form of intraoral scan data sets, each of which may include 3D intraoral scans (e.g., first sets of 2D images generated using structured light projection or 3D point clouds generated from such first sets of 2D images) of particular teeth and/or regions of an dental site, second sets of intraoral images (e.g., color images), and so on. In one embodiment, separate intraoral scan data sets are created for the maxillary arch, for the mandibular arch, for a patient bite, and/or for each preparation tooth. Alternatively, a single large intraoral scan data set is generated (e.g., for a mandibular and/or maxillary arch). Intraoral scans may be provided from the scanner 150 to the computing device 105 in the form of one or more points (e.g., one or more pixels and/or groups of pixels), 3D point clouds, sets of 2D images, 3D meshes, or other data representation. For instance, the scanner 150 may provide an intraoral scan as one or more 3D point clouds.

The manner in which the oral cavity of a patient is to be scanned may depend on the procedure to be applied thereto. For example, if an upper or lower denture is to be created, then a full scan of the mandibular or maxillary edentulous arches may be performed. In contrast, if a bridge is to be created, then just a portion of a total arch may be scanned which includes an edentulous region, the neighboring preparation teeth (e.g., abutment teeth) and the opposing arch and dentition. Alternatively, full scans of upper and/or lower dental arches may be performed if a bridge is to be created.

By way of non-limiting example, dental procedures may be broadly divided into prosthodontic (restorative) and orthodontic procedures, and then further subdivided into specific forms of these procedures. Additionally, dental procedures may include identification and treatment of gum disease, sleep apnea, and intraoral conditions. The term prosthodontic procedure refers, inter alia, to any procedure involving the oral cavity and directed to the design, manufacture or installation of a dental prosthesis at a dental site within the oral cavity (dental site), or a real or virtual model thereof, or directed to the design and preparation of the dental site to receive such a prosthesis. A prosthesis may include any restoration such as crowns, veneers, inlays, onlays, implants and bridges, for example, and any other artificial partial or complete denture. The term orthodontic procedure refers, inter alia, to any procedure involving the oral cavity and directed to the design, manufacture or installation of orthodontic elements at a dental site within the oral cavity, or a real or virtual model thereof, or directed to the design and preparation of the dental site to receive such orthodontic elements. These elements may be appliances including but not limited to brackets and wires, retainers, clear aligners, or functional appliances.

In embodiments, intraoral scanning may be performed on a patient's oral cavity during a visitation of dental office 108. The intraoral scanning may be performed, for example, as part of a semi-annual or annual dental health checkup. The intraoral scanning may also be performed before, during and/or after one or more dental treatments, such as orthodontic treatment and/or prosthodontic treatment. The intraoral scanning may be a full or partial scan of the upper and/or lower dental arches, and may be performed in order to gather information for performing dental diagnostics, to generate a treatment plan, to determine progress of a treatment plan, and/or for other purposes. The dental information (intraoral scan data 135A-N) generated from the intraoral scanning may include 3D scan data (e.g., 3D point clouds and/or sets of images captured using structured light projection used to generate 3D point clouds), 2D color images, NIRI and/or infrared images, and/or ultraviolet images, of all or a portion of the upper jaw and/or lower jaw. The intraoral scan data 135A-N may further include one or more intraoral scans showing a relationship of the upper dental arch to the lower dental arch. These intraoral scans may be usable to determine a patient bite and/or to determine occlusal contact information for the patient. The patient bite may include determined relationships between teeth in the upper dental arch and teeth in the lower dental arch.

For many prosthodontic procedures (e.g., to create a crown, bridge, veneer, etc.), an existing tooth of a patient is ground down to a stump. The ground tooth is referred to herein as a preparation tooth, or simply a preparation. The preparation tooth has a margin line (also referred to as a finish line), which is a border between a natural (unground) portion of the preparation tooth and the prepared (ground) portion of the preparation tooth. The preparation tooth is typically created so that a crown or other prosthesis can be mounted or seated on the preparation tooth. In many instances, the margin line of the preparation tooth is sub-gingival (below the gum line).

Intraoral scanners may work by moving the scanner 150 inside a patient's mouth to capture all viewpoints of one or more tooth. During scanning, the scanner 150 is calculating distances to solid surfaces in some embodiments. These distances may be recorded as images called ‘height maps’ or as point clouds in some embodiments. Each scan (e.g., optionally height map or point cloud) is overlapped algorithmically, or ‘stitched’, with the previous set of scans to generate a growing 3D surface. As such, each scan is associated with a rotation in space, or a projection, to how it fits into the 3D surface.

During intraoral scanning, intraoral scan application 115 may register and stitch together two or more intraoral scans (e.g., 3D points clouds or meshes) generated thus far from the intraoral scan session to generate a growing 3D surface. In one embodiment, performing registration includes capturing 3D data of various points of a surface in multiple intraoral scans, and registering the scans by computing transformations between the scans. One or more 3D surfaces may be generated based on the registered and stitched together intraoral scans during the intraoral scanning. The one or more 3D surfaces may be output to a display so that a doctor or technician can view their scan progress thus far.

In embodiments, bodily fluid detection is performed for each intraoral scan and/or 3D surface. For example, bodily fluid detection may be performed for each intraoral scan before that intraoral scan is registered to other intraoral scans and/or to a 3D surface already constructed from other intraoral scans. A bodily fluid detection algorithm or sequence of algorithms or operations may be performed to identify bodily fluids in the intraoral scans. Points in the intraoral scans (e.g., 3D point clouds or meshes) identified as depicting a bodily fluid may then not be included in the 3D surface when that intraoral scan is stitched to the 3D surface. This may include removing or filtering out the bodily fluid points in some embodiments.

As each new intraoral scan is captured and registered to previous intraoral scans and/or a 3D surface, the one or more 3D surfaces may be updated, and the updated 3D surface(s) may be output to the display. A view of the 3D surface(s) may be periodically or continuously updated according to one or more viewing modes of the intraoral scan application. In one viewing mode, the 3D surface may be continuously updated such that an orientation of the 3D surface that is displayed aligns with a field of view of the intraoral scanner (e.g., so that a portion of the 3D surface that is based on a most recently generated intraoral scan is approximately centered on the display or on a window of the display) and a user sees what the intraoral scanner sees. In one viewing mode, a position and orientation of the 3D surface is static, and an image of the intraoral scanner is optionally shown to move relative to the stationary 3D surface. Other viewing modes may include zoomed in viewing modes that show magnified views of one or more regions of the 3D surface (e.g., of intraoral areas of interest (AOIs). Other viewing modes are also possible.

In embodiments, since bodily fluid points may not be used in the generated 3D surface, voids may form in the 3D surface. These voids may represent areas on a dental site where bodily fluids are present. In order to fill in the data for such voids, a dental practitioner may use air, suction, wiping, or other techniques to remove the bodily fluid from the dental site. The dental practitioner may then continue to perform intraoral scanning of those regions where voids are shown in the 3D surface. The newly captured intraoral scans may then be stitched to the 3D surface, and data may be added that fills in the voids.

In embodiments, separate 3D surfaces are generated for the upper jaw and the lower jaw. This process may be performed in real time or near-real time to provide an updated view of the captured 3D surfaces during the intraoral scanning process.

When a scan session or a portion of a scan session associated with a particular scanning role (e.g., upper jaw role, lower jaw role, bite role, etc.) is complete (e.g., all scans for an dental site or dental site have been captured), intraoral scan application 115 may generate a virtual 3D model of one or more scanned dental sites (e.g., of an upper jaw and a lower jaw). The final 3D model may be a set of 3D points and their connections with each other (i.e. a mesh). To generate the virtual 3D model, intraoral scan application 115 may register and stitch together the intraoral scans generated from the intraoral scan session that are associated with a particular scanning role (e.g., upper dental arch, lower dental arch, bite, preparation, etc.). The registration performed at this stage may be more accurate than the registration performed during the capturing of the intraoral scans, and may take more time to complete than the registration performed during the capturing of the intraoral scans. In one embodiment, performing scan registration includes capturing 3D data of various points of a surface in multiple scans, and registering the scans by computing transformations between the scans. The 3D data may be projected into a 3D space of a 3D model to form a portion of the 3D model. The intraoral scans may be integrated into a common reference frame by applying appropriate transformations to points of each registered scan and projecting each scan into the 3D space.

In one embodiment, registration is performed for adjacent or overlapping intraoral scans (e.g., each successive frame of an intraoral video). Registration algorithms are carried out to register two adjacent or overlapping intraoral scans and/or to register an intraoral scan with a 3D model, which essentially involves determination of the transformations which align one scan with the other scan and/or with the 3D model. Registration may involve identifying multiple points in each scan (e.g., point clouds) of a scan pair (or of a scan and the 3D model), surface fitting to the points, and using local searches around points to match points of the two scans (or of the scan and the 3D model). For example, intraoral scan application 115 may match points of one scan with the closest points interpolated on the surface of another scan, and iteratively minimize the distance between matched points. Other registration techniques may also be used.

Intraoral scan application 115 may repeat registration for all intraoral scans of a sequence of intraoral scans to obtain transformations for each intraoral scan, to register each intraoral scan with previous intraoral scan(s) and/or with a common reference frame (e.g., with the 3D model). Intraoral scan application 115 may integrate intraoral scans into a single virtual 3D model by applying the appropriate determined transformations to each of the intraoral scans. Each transformation may include rotations about one to three axes and translations within one to three planes.

Intraoral scan application 115 may generate one or more 3D models from intraoral scans, and may display the 3D models to a user (e.g., a doctor) via a graphical user interface (GUI). The 3D models can then be checked visually by the doctor. The doctor can virtually manipulate the 3D models via the user interface with respect to up to six degrees of freedom (i.e., translated and/or rotated with respect to one or more of three mutually orthogonal axes) using suitable user controls (hardware and/or virtual) to enable viewing of the 3D model from any desired direction.

Intraoral scan application 115 may include a bodily fluid identifier 116, a scan registration module 118, a user interface 140 and/or a model generation module 120 in some embodiments. The modules 116, 118, 120, 140 may be software modules that are components of a single software application (e.g., different libraries of a single intraoral scan application 115), may be distinct software applications, may be firmware, may be hardware modules, and/or a combination thereof.

Bodily fluid identifier 116 may analyze received intraoral scan data 135A-N using one or more of the techniques described herein below to identify bodily fluids in the intraoral images of the intraoral scan data 135A-N. Scan registration module 118 may register intraoral scans together (e.g., after bodily fluid points have been identified in the scans and optionally filtered out or removed), and model generation module 120 may generate a 3D model based on registered intraoral scans.

In the illustrated example, bodily fluid identifier 116, scan registration module 118 and model generation module 120 are all included in intraoral scan application that executes on computing device 115.

In some embodiments, bodily fluid identifier 116, scan registration module 118 and/or model generation module 120 execute on a remote server computing device. In some embodiments, the intraoral scans may be transmitted from the scanner 150 or from computing device 105 to the remote server computing device, which may process the intraoral scans and transmit updated intraoral scans and/or a 3D surface or 3D model, or a portion thereof, to computing device 105 (e.g., for output to a display of computing device 105). Accordingly, in some embodiments at last some processing may be offloaded from computing device 105 to the remote server computing device.

In an example, computing device 105 may receive intraoral scan data comprising one or more intraoral images of a portion of a dental site generated using structured light projection during intraoral scanning of the dental site. Computing device 105 may then generate a three-dimensional (3D) point cloud of the portion of the dental site using the intraoral scan data. Alternatively, computing device 105 may receive intraoral scan data comprising a 3D point cloud generated from one or more images. In either case, computing device 105 may transmit the 3D point cloud to a second computing device. The second computing device may detect one or more regions of the 3D point cloud comprising a bodily fluid, remove the one or more regions from the 3D point cloud, update a 3D surface of the dental site using the 3D point cloud of the portion of the dental site, and transmit the 3D surface of the dental site to the first computing device. The first computing device may then output the 3D surface to a display.

In some embodiments, bodily fluid identifier 116 is integrated into scanner 150. For example, a processor of intraoral scanner 150 may process captured images and/or intraoral scan data to identify bodily fluids, and may update images and/or intraoral scan data prior to transmitting the images and/or intraoral scan data to computing device 105 for further processing. In one embodiment, the intraoral scanner 150 is configured to generate a structured light pattern using a plurality of structured light projectors, capture a plurality of images of a portion of a dental site illuminated by the structured light pattern using a plurality of cameras, generate a three-dimensional (3D) point cloud of the portion of the dental site using at least some of the plurality of images, detect one or more regions of the 3D point cloud comprising a bodily fluid, remove the one or more regions from the 3D point cloud, and transmit the 3D point cloud to a computing device for further processing.

User interface 140 may be a graphical user interface (GUI). User interface 140 may function during an intraoral scan session. As scanner 150 generates intraoral images and those intraoral images are processed by bodily fluid identifier 116, a view screen showing a two-dimensional (2D) or 3D representation of a scanned dental site may be output to a display (e.g., of computing device 105). Bodily fluids that have been filtered out by bodily fluid identifier 116 may not be shown in the 2D or 3D representation.

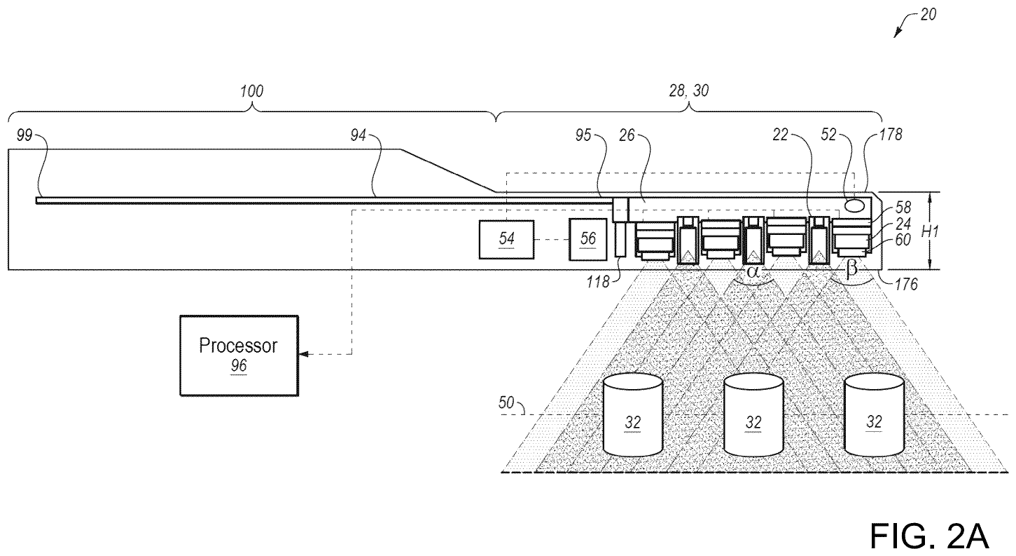

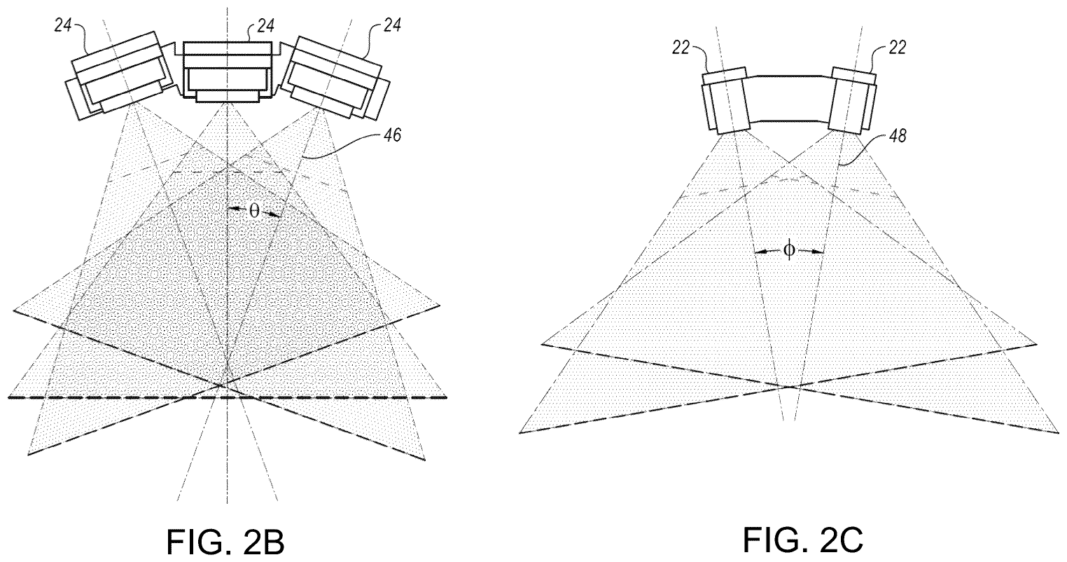

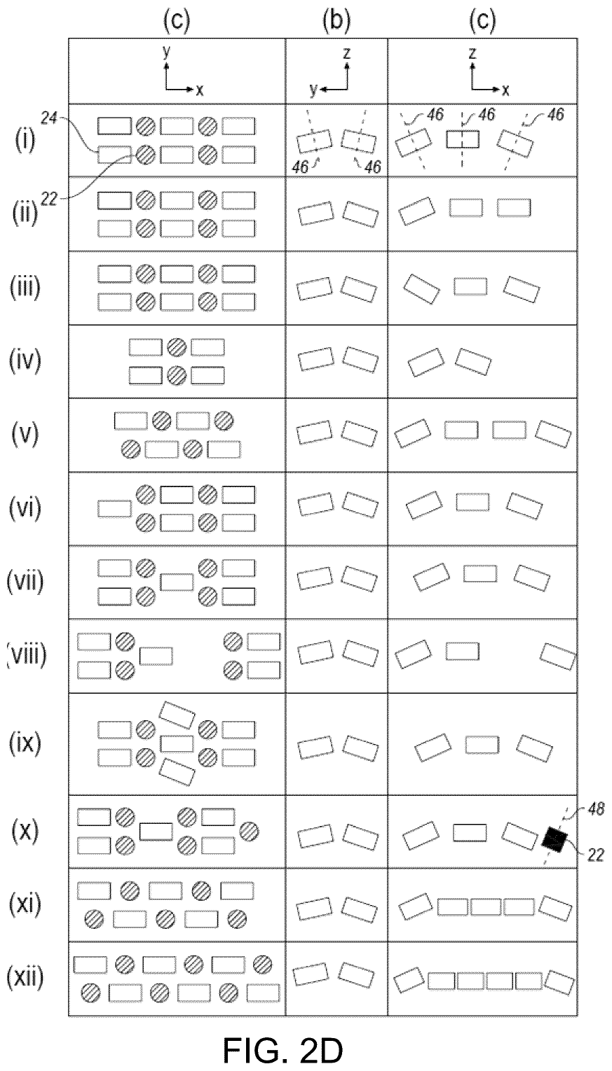

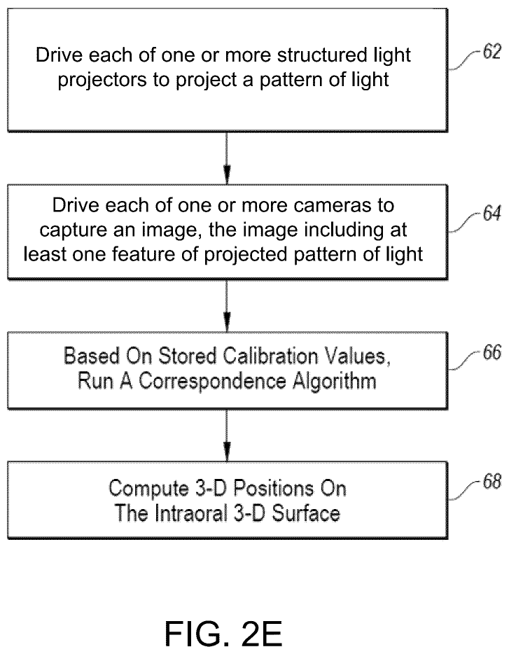

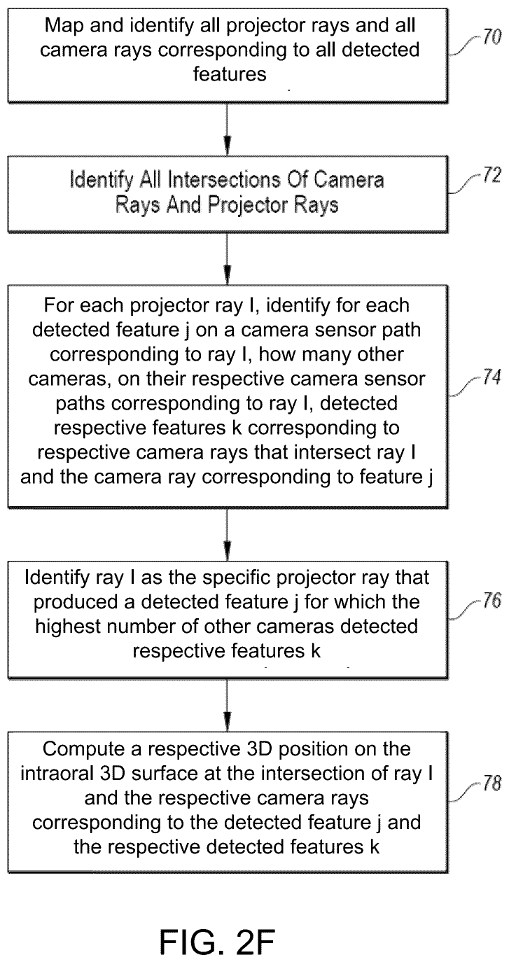

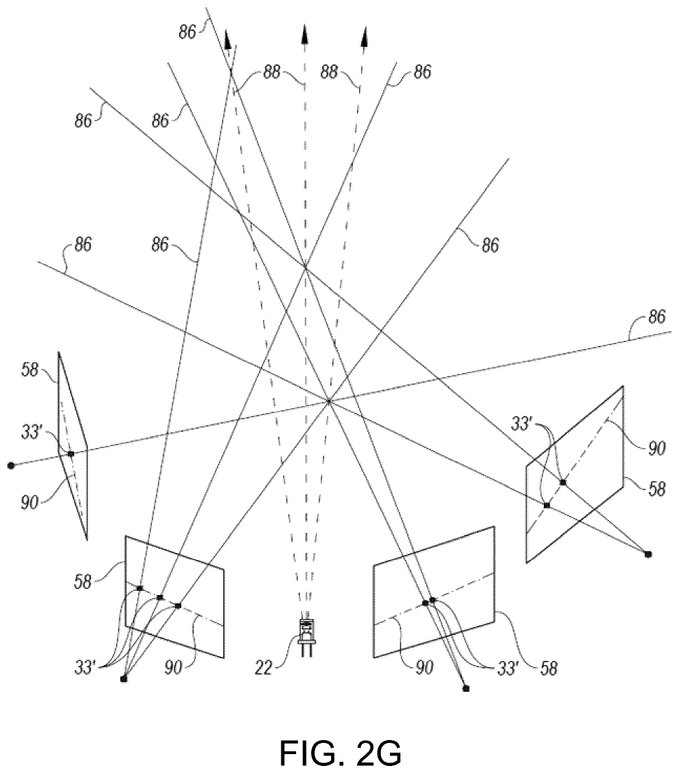

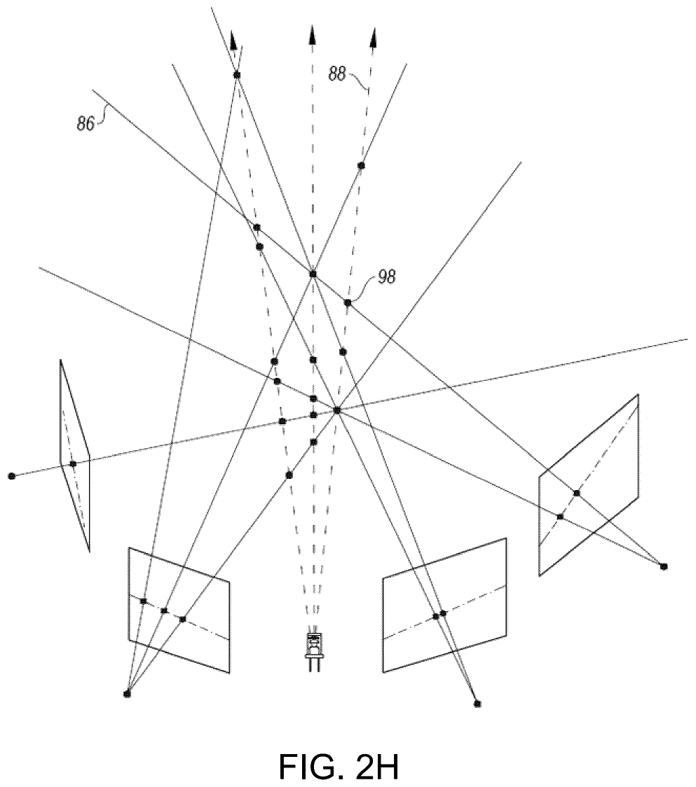

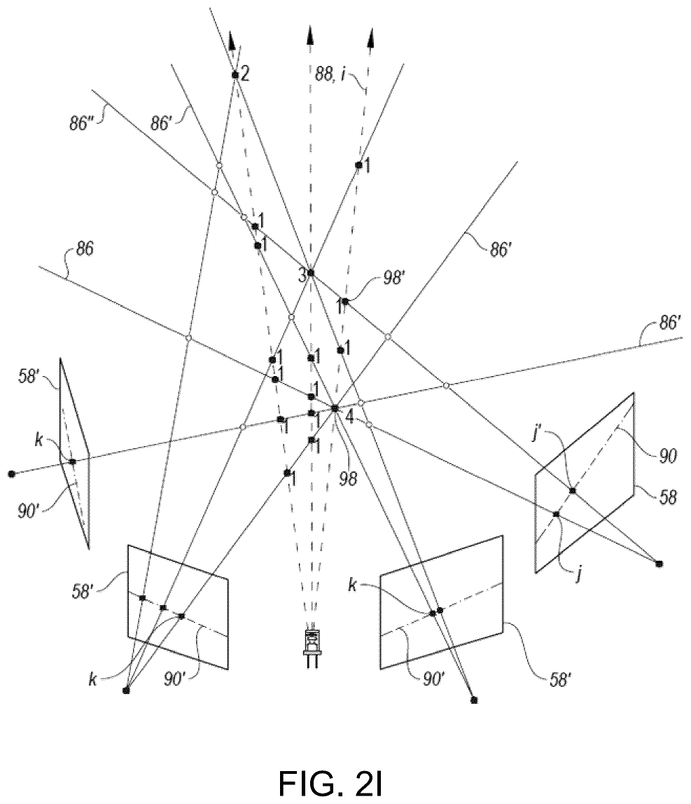

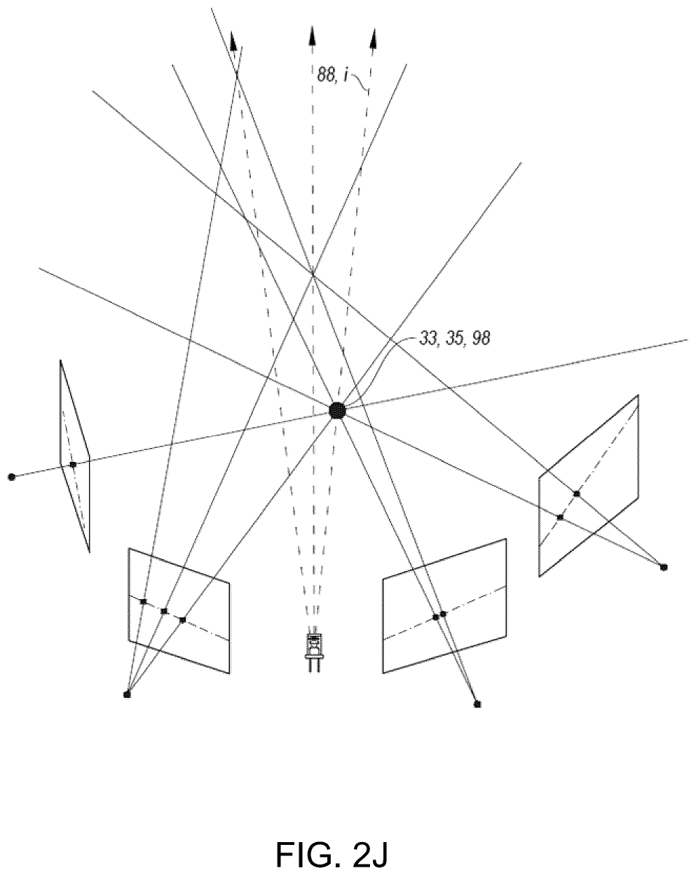

Reference is now made to FIG. 2A, which is a schematic illustration of an intraoral scanner 20 comprising an elongate wand, in accordance with some applications of the present disclosure. The intraoral scanner 20 may correspond to intraoral scanner 150 of FIG. 1 in embodiments. Intraoral scanner 20 includes a plurality of structured light projectors 22 and a plurality of cameras 24 that may be coupled to a rigid structure 26 disposed within a probe 28 at a distal end 30 of the intraoral scanner 20. In some applications, during an intraoral scanning procedure, probe 28 is inserted into the oral cavity of a subject or patient.

For some applications, structured light projectors 22 are positioned within probe 28 such that each structured light projector 22 faces an object 32 outside of intraoral scanner 20 that is placed in its field of illumination, as opposed to positioning the structured light projectors in a proximal region of the handheld wand and illuminating the object by reflection of light off a mirror and subsequently onto the object. Alternatively, the structured light projectors may be disposed in the wand such that they are directed toward a mirror, which may be used to reflect structured light generated by the structured light projectors onto object 32. Similarly, for some applications, cameras 24 are positioned within probe 28 such that each camera 24 faces an object 32 outside of intraoral scanner 20 that is placed in its field of view, as opposed to positioning the cameras in a proximal region of the intraoral scanner and viewing the object by reflection of light off a mirror and into the camera. Alternatively, one or more cameras may be disposed in the wand such that they are aimed at the mirror, where the mirror may reflect returning light reflected from object 32 back to the one or more cameras.

In some embodiments, the intraoral scanner 20 includes multiple image capture modules, each of which includes one or more structured light projectors and one or more cameras. Each image capture module may be aimed at a mirror that reflects structured light onto object 32 and returning light from object 32 back to the one or more cameras. Different image capture modules may be associated with their own separate mirror in some embodiments. Positioning of the projectors and the cameras within probe 28 enables the scanner to have an overall large field of view while maintaining a low profile probe. In some embodiments, the cameras may be disposed in a proximal region of the handheld wand.

In some applications, cameras 24 each have a large field of view β (beta) of at least 45 degrees, at least 70 degrees, at least 80 degrees, 85 degrees, or another amount. In some applications, the field of view may be less than 120 degrees, less than 100 degrees, less than 90 degrees, or another amount. In one embodiment, a field of view β (beta) for each camera is between 80 and 90 degrees, which may be particularly useful because it provided a good balance among pixel size, field of view and camera overlap, optical quality, and cost. Cameras 24 may include an image sensor 58 and objective optics 60 including one or more lenses. To enable close focus imaging, cameras 24 may focus at an object focal plane 50 that is located between 1 mm and 30 mm, between 4 mm and 24 mm, between 5 mm and 11 mm, 9 mm-10 mm, 10-50 mm, 10-30 mm, etc. from the lens that is farthest from the sensor. In some applications, cameras 24 may capture images at a frame rate of at least 30 frames per second, e.g., at a frame of at least 75 frames per second, at least 100 frames per second, and so on. In some applications, the frame rate may be less than 200 frames per second.

A large field of view achieved by combining the respective fields of view of all the cameras may improve accuracy due to reduced amount of image stitching errors, especially in edentulous regions, where the gum surface is smooth and there may be fewer clear high resolution 3D features. Having a larger field of view enables large smooth features, such as the overall curve of the tooth, to appear in each image frame, which improves the accuracy of stitching respective surfaces obtained from multiple such image frames.

Similarly, structured light projectors 22 may each have a large field of illumination α (alpha) of at least 45 degrees, e.g., at least 70 degrees. In some applications, field of illumination α (alpha) may be less than 120 degrees, e.g., than 100 degrees. Each structured light pattern may be configured to generate the same or a different pattern of structured light, and may use the same or a different wavelength of light. Examples of light patterns that may be projected include spots, a checkerboard pattern, a pattern of repeating shapes such as triangles, hexagons, octagons, squares, rectangles, etc. The repeating shapes may be arranged in a tessellating pattern in some embodiments. In some embodiments, the pattern of light projected by the structured light projectors does not vary with time. However, the pattern of light may be turned on and off in embodiments (e.g., to alternate between white light illumination for color 2D image capture and structured light projection for 3D intraoral scan capture).

For some applications, in order to improve image capture, each camera 24 has a plurality of discrete preset focus positions, in each focus position the camera focusing at a respective object focal plane 50. Each of cameras 24 may include an autofocus actuator that selects a focus position from the discrete preset focus positions in order to improve a given image capture. Additionally or alternatively, each camera 24 includes an optical aperture phase mask that extends a depth of focus of the camera, such that images formed by each camera are maintained focused over all object distances located between 1 mm and 30 mm, between 4 mm and 24 mm, between 5 mm and 11 mm, 9 mm-10 mm, 10-30 mm, 10-50 mm, etc. from the lens that is farthest from the sensor.

In some applications, structured light projectors 22 and cameras 24 are coupled to rigid structure 26 in a closely packed and/or alternating fashion, such that (a) a substantial part of each camera's field of view overlaps the field of view of neighboring cameras, and (b) a substantial part of each camera's field of view overlaps the field of illumination of neighboring projectors. Optionally, at least 20%, e.g., at least 50%, e.g., at least 75% of the projected pattern of light are in the field of view of at least one of the cameras at an object focal plane 50 that is located at least 4 mm from the lens that is farthest from the sensor. Due to different possible configurations of the projectors and cameras, some of the projected pattern may never be seen in the field of view of any of the cameras, and some of the projected pattern may be blocked from view by object 32 as the scanner is moved around during a scan.

Rigid structure 26 may be a non-flexible structure to which structured light projectors 22 and cameras 24 are coupled so as to provide structural stability to the optics within probe 28. Coupling all the projectors and all the cameras to a common rigid structure helps maintain geometric integrity of the optics of each structured light projector 22 and each camera 24 under varying ambient conditions, e.g., under mechanical stress as may be induced by the subject's mouth. Additionally, rigid structure 26 helps maintain stable structural integrity and positioning of structured light projectors 22 and cameras 24 with respect to each other.

Reference is now made to FIGS. 2B-2C, which include schematic illustrations of examples of a positioning configuration for cameras 24 and structured light projectors 22 respectively, in accordance with some applications of the present disclosure. For some applications, in order to improve the overall field of view and field of illumination of the intraoral scanner 20, cameras 24 and structured light projectors 22 are positioned such that they do not all face the same direction. For some applications, such as is shown in FIG. 2B, a plurality of cameras 24 are coupled to rigid structure 26 such that an angle θ (theta) between two respective optical axes 46 of at least two cameras 24 is 90 degrees or less, e.g., 35 degrees or less. Similarly, for some applications, such as is shown in FIG. 2C, a plurality of structured light projectors 22 are coupled to rigid structure 26 such that an angle φ (phi) between two respective optical axes 48 of at least two structured light projectors 22 is 90 degrees or less, e.g., 35 degrees or less.

Reference is now made to FIG. 2D, which is a chart depicting a plurality of different configurations for the position of structured light projectors 22 and cameras 24 in probe 28, in accordance with some applications of the present disclosure. Structured light projectors 22 are represented in FIG. 2D by circles and cameras 24 are represented in FIG. 2D by rectangles. It is noted that rectangles are used to represent the cameras, since typically, each image sensor 58 and the field of view β (beta) of each camera 24 have aspect ratios of 1:2. Column (a) of FIG. 2D shows a bird's eye view of the various configurations of structured light projectors 22 and cameras 24. The x-axis as labeled in the first row of column (a) corresponds to a central longitudinal axis of probe 28. Column (b) shows a side view of cameras 24 from the various configurations as viewed from a line of sight that is coaxial with the central longitudinal axis of probe 28 and substantially parallel to a viewing axis of the intraoral scanner. Similarly to as shown in FIG. 2B, column (b) of FIG. 2D shows cameras 24 positioned so as to have optical axes 46 at an angle of 90 degrees or less, e.g., 35 degrees or less, with respect to each other. Column (c) shows a side view of cameras 24 of the various configurations as viewed from a line of sight that is perpendicular to the central longitudinal axis of probe 28.

In some instances, the distal-most (toward the positive x-direction in FIG. 2D) and proximal-most (toward the negative x-direction in FIG. 2D) cameras 24 may be positioned such that their optical axes 46 are slightly turned inwards, e.g., at an angle of 90 degrees or less, e.g., 35 degrees or less, with respect to the next closest camera 24. The camera(s) 24 that are more centrally positioned, i.e., not the distal-most camera 24 nor proximal-most camera 24, may be positioned so as to face directly out of the probe, their optical axes 46 being substantially perpendicular to the central longitudinal axis of probe 28. It is noted that in row (xi) a projector 22 may be positioned in the distal-most position of probe 28, and as such the optical axis 48 of that projector 22 points inwards, allowing a larger number of spots 33 projected from that particular projector 22 to be seen by more cameras 24.

In embodiments, the number of structured light projectors 22 in probe 28 may range from two, e.g., as shown in row (iv) of FIG. 2D, to six, e.g., as shown in row (xii). In some instances, the number of cameras 24 in probe 28 may range from four, e.g., as shown in rows (iv) and (v), to seven or eight, e.g., as shown in row (ix). It is noted that the various configurations shown in FIG. 2D are by way of example and not limitation, and that the scope of the present disclosure includes additional configurations not shown. For example, the scope of the present disclosure includes fewer or more than five projectors 22 positioned in probe 28 and fewer or more than seven cameras positioned in probe 28.

In an example application, an apparatus for intraoral scanning (e.g., an intraoral scanner 150) includes an elongate wand comprising a probe at a distal end of the elongate wand, at least two light projectors disposed within the probe, and at least four cameras disposed within the probe. Each light projector may include at least one light source configured to generate light when activated, and a pattern generating optical element that is configured to generate a pattern of light when the light is transmitted through the pattern generating optical element. Each of the at least four cameras may include a camera sensor (also referred to as an image sensor) and one or more lenses, wherein each of the at least four cameras is configured to capture a plurality of images that depict at least a portion of the projected pattern of light on an intraoral surface. A majority of the at least two light projectors and the at least four cameras may be arranged in at least two rows that are each approximately parallel to a longitudinal axis of the probe, the at least two rows comprising at least a first row and a second row.

In a further application, a distal-most camera along the longitudinal axis and a proximal-most camera along the longitudinal axis of the at least four cameras are positioned such that their optical axes are at an angle of 90 degrees or less with respect to each other from a line of sight that is perpendicular to the longitudinal axis. Cameras in the first row and cameras in the second row may be positioned such that optical axes of the cameras in the first row are at an angle of 90 degrees or less with respect to optical axes of the cameras in the second row from a line of sight that is coaxial with the longitudinal axis of the probe. A remainder of the at least four cameras other than the distal-most camera and the proximal-most camera have optical axes that are substantially parallel to the longitudinal axis of the probe. Each of the at least two rows may include an alternating sequence of light projectors and cameras.

In a further application, the at least four cameras comprise at least five cameras, the at least two light projectors comprise at least five light projectors, a proximal-most component in the first row is a light projector, and a proximal-most component in the second row is a camera.

In a further application, the distal-most camera along the longitudinal axis and the proximal-most camera along the longitudinal axis are positioned such that their optical axes are at an angle of 35 degrees or less with respect to each other from the line of sight that is perpendicular to the longitudinal axis. The cameras in the first row and the cameras in the second row may be positioned such that the optical axes of the cameras in the first row are at an angle of 35 degrees or less with respect to the optical axes of the cameras in the second row from the line of sight that is coaxial with the longitudinal axis of the probe.

In a further application, the at least four cameras may have a combined field of view of 25-45 mm along the longitudinal axis and a field of view of 20-40 mm along a z-axis corresponding to distance from the probe.

Returning to FIG. 2A, for some applications, there is at least one uniform light projector 118 (which may be an unstructured light projector that projects light across a range of wavelengths) coupled to rigid structure 26. Uniform light projector 118 may transmit white light onto object 32 being scanned. At least one camera, e.g., one or all of cameras 24, captures two-dimensional color images of object 32 using illumination from uniform light projector 118.

Processor 96 may run a surface reconstruction algorithm that may use detected patterns (e.g., dot patterns, patterns of features such as features of a checkerboard, etc.) projected onto object 32 to generate a 3D surface of the object 32.

FIG. 2E is a flow chart outlining a method for generating a digital three-dimensional point cloud or image, in accordance with some applications of the present disclosure. In blocks 62 and 64, respectively, each structured light projector of an intraoral scanner is driven to project a pattern of light on an intraoral three-dimensional surface, and each camera of the intraoral scanner is driven to capture an image that includes at least one feature of the pattern of light. Based on stored calibration values indicating (a) a camera ray corresponding to each pixel on a camera sensor of each camera, and (b) a projector ray corresponding to each projected feature from each structured light projector, a correspondence algorithm is run in block 66, further described hereinbelow with reference to FIGS. 2F-I. Once the correspondence is solved, three-dimensional positions on the intraoral surface are computed in block 68 and used to generate a digital three-dimensional image or point cloud of the intraoral surface.

Reference is now made to FIG. 2F, which is a flowchart outlining the correspondence algorithm of block 66 in FIG. 2E, in accordance with some applications of the present disclosure. Reference is also made to and to FIGS. 2G-2I. Based on stored calibration values, all projector rays 88 and all camera rays 86 corresponding to all detected features of the projected pattern of light are mapped (block 70), and all intersections 98 (FIG. 2H) of at least one camera ray 86 and at least one projector ray 88 are identified (block 72). FIGS. 2G-H are schematic illustrations of a simplified example of blocks 70 and 72, respectively. As shown in FIG. 2G, three projector rays 88 are mapped along with eight camera rays 86 corresponding to a total of eight detected features 33′ on camera sensors 58 of cameras 24. As shown in FIG. 2H, sixteen intersections 98 are identified.

In blocks 74 and 76 of FIG. 2F, processing logic determines a correspondence between projected features 33 and detected features 33′ so as to identify a three-dimensional location for each projected features 33 on the surface. FIG. 2I is a schematic illustration depicting blocks 74 and 76 of FIG. 2F using the simplified example described hereinabove in the immediately preceding paragraph. For a given projector ray i, processing logic “looks” at the corresponding camera sensor path 90 on a camera sensor. Each detected feature j along camera sensor path 90 will have a camera ray 86 that intersects given projector ray i, at an intersection 98. Intersection 98 defines a three-dimensional point in space. Processing logic further “looks” at camera sensor paths 90′ that correspond to given projector ray i on respective camera sensors of other cameras, and identifies how many other cameras, on their respective camera sensor paths 90′ corresponding to given projector ray i, also detected respective features k whose camera rays 86′ intersect with that same three-dimensional point in space defined by intersection 98. The process is repeated for all detected features j along camera sensor path 90, and the feature j for which the highest number of cameras 24 “agree,” is identified as the feature that is being projected onto the surface from given projector ray i. That is, projector ray i is identified as the specific projector ray 88 that produced a detected feature j for which the highest number of other cameras detected respective features k. A three-dimensional position on the surface is thus computed for that feature.

For example, as shown in FIG. 2I, all four of the cameras detect respective features, on their respective camera sensor paths corresponding to projector ray i, whose respective camera rays intersect projector ray i at intersection 98, intersection 98 being defined as the intersection of camera ray 86 corresponding to detected feature j and projector ray i. Hence, all four cameras are said to “agree” on there being a feature 33 projected by projector ray i at intersection 98. When the process is repeated for a next feature j′, however, none of the other cameras detect respective features, on their respective camera sensor paths corresponding to projector ray i, whose respective camera rays intersect projector ray i at intersection 98′, intersection 98′ being defined as the intersection of camera ray 86″ (corresponding to detected feature j′) and projector ray i. Thus, with reference to FIG. 2J, only one camera is said to “agree” on there being a feature 33 projected by projector ray i at intersection 98′, while four cameras “agree” on there being a feature 33 projected by projector ray i at intersection 98. Projector ray i is therefore identified as being the specific projector ray 88 that produced detected feature j, by projecting a feature 33 onto the surface at intersection 98. As per block 78 of FIG. 2F, and as shown in FIG. 2I, a three-dimensional position 35 on the intraoral surface is computed at intersection 98.

In some embodiments, the processor 96 may combine at least one 3D scan captured using illumination from structured light projectors 22 with a plurality of intraoral 2D images captured using illumination from uniform light projector 118 in order to generate a digital three-dimensional image of the intraoral three-dimensional surface. Using a combination of structured light and uniform illumination enhances the overall capture of the intraoral scanner and may help reduce the number of options that processor 96 needs to consider when running a correspondence algorithm used to detect depth values for object 32. In one embodiment, the intraoral scanner and correspondence algorithm described in U.S. Pat. No. 11,534,273, issued Dec. 27, 2022, is used. U.S. Pat. No. 11,534,273, issued Dec. 27, 2022, is incorporated by reference herein in its entirety. In one embodiment, the intraoral scanner and correspondence algorithm described in U.S. Pat. No. 11,563,929, issued Jan. 24, 2023, is used. U.S. Pat. No. 11,563,929, issued Jan. 24, 2023, is incorporated by reference herein in its entirety. In embodiments, processor 92 may be a processor of computing device 105 of FIG. 1. Alternatively, processor 92 may be a processor integrated into the intraoral scanner 20.

For some applications, all data points taken at a specific time are used as a rigid point cloud, and multiple such point clouds are captured at a frame rate of over 10 captures per second. The plurality of point clouds are then stitched together using a registration algorithm, e.g., iterative closest point (ICP), to create a dense point cloud. A surface reconstruction algorithm may then be used to generate a representation of the surface of object 32.

For some applications, at least one temperature sensor 52 is coupled to rigid structure 26 and measures a temperature of rigid structure 26. Temperature control circuitry 54 disposed within intraoral scanner 20 (a) receives data from temperature sensor 52 indicative of the temperature of rigid structure 26 and (b) activates a temperature control unit 56 in response to the received data. Temperature control unit 56, e.g., a PID controller, keeps probe 28 at a desired temperature (e.g., between 35 and 43 degrees Celsius, between 37 and 41 degrees Celsius, etc.). Keeping probe 28 above 35 degrees Celsius, e.g., above 37 degrees Celsius, reduces fogging of the glass surface of intraoral scanner 20, through which structured light projectors 22 project and cameras 24 view, as probe 28 enters the intraoral cavity, which is typically around or above 37 degrees Celsius. Keeping probe 28 below 43 degrees, e.g., below 41 degrees Celsius, prevents discomfort or pain.

In some embodiments, heat may be drawn out of the probe 28 via a heat conducting element 94, e.g., a heat pipe, that is disposed within intraoral scanner 20, such that a distal end 95 of heat conducting element 94 is in contact with rigid structure 26 and a proximal end 99 is in contact with a proximal end 100 of intraoral scanner 20. Heat is thereby transferred from rigid structure 26 to proximal end 100 of intraoral scanner 20. Alternatively or additionally, a fan disposed in a handle region 174 of intraoral scanner 20 may be used to draw heat out of probe 28.

FIGS. 2A-2D illustrate one type of intraoral scanner that can be used for embodiments of the present disclosure. However, it should be understood that embodiments are not limited to the illustrated type of intraoral scanner.

In some embodiments an intraoral scanner that performs confocal focusing to determine depth information may be used. Such an intraoral scanner may include a light source and/or illumination module that emits light (e.g., a focused light beam or array of focused light beams). The light passes through a polarizer and through a unidirectional mirror or beam splitter (e.g., a polarizing beam splitter) that passes the light. The light may pass through a pattern before or after the beam splitter to cause the light to become patterned light. Along an optical path of the light after the unidirectional mirror or beam splitter are optics, which may include one or more lens groups. Any of the lens groups may include only a single lens or multiple lenses. One of the lens groups may include at least one moving lens.

The light may pass through an endoscopic probing member, which may include a rigid, light-transmitting medium, which may be a hollow object defining within it a light transmission path or an object made of a light transmitting material, e.g. a glass body or tube. In one embodiment, the endoscopic probing member includes a prism such as a folding prism. At its end, the endoscopic probing member may include a mirror of the kind ensuring a total internal reflection. Thus, the mirror may direct the array of light beams towards a teeth segment or other object. The endoscope probing member thus emits light, which optionally passes through one or more windows and then impinges on to surfaces of intraoral objects.

The light may include an array of light beams arranged in an X-Y plane, in a Cartesian frame, propagating along a Z axis, which corresponds to an imaging axis or viewing axis of the intraoral scanner. As the surface on which the incident light beams hits is an uneven surface, illuminated spots may be displaced from one another along the Z axis, at different (Xᵢ, Yᵢ) locations. Thus, while a spot at one location may be in focus of the confocal focusing optics, spots at other locations may be out-of-focus. Therefore, the light intensity of returned light beams of the focused spots will be at its peak, while the light intensity at other spots will be off peak. Thus, for each illuminated spot, multiple measurements of light intensity are made at different positions along the Z-axis. For each of such (Xᵢ, Yᵢ) location, the derivative of the intensity over distance (Z) may be made, with the Zᵢ yielding maximum derivative, Z₀, being the in-focus distance.

The light reflects off of intraoral objects and passes back through windows (if they are present), reflects off of the mirror, passes through the optical system, and is reflected by the beam splitter onto a detector. The detector is an image sensor having a matrix of sensing elements each representing a pixel of the scan or image. In one embodiment, the detector is a charge coupled device (CCD) sensor. In one embodiment, the detector is a complementary metal-oxide semiconductor (CMOS) type image sensor. Other types of image sensors may also be used for detector. In one embodiment, the detector detects light intensity at each pixel, which may be used to compute height or depth.

Alternatively, in some embodiments an intraoral scanner that uses stereo imaging is used to determine depth information.

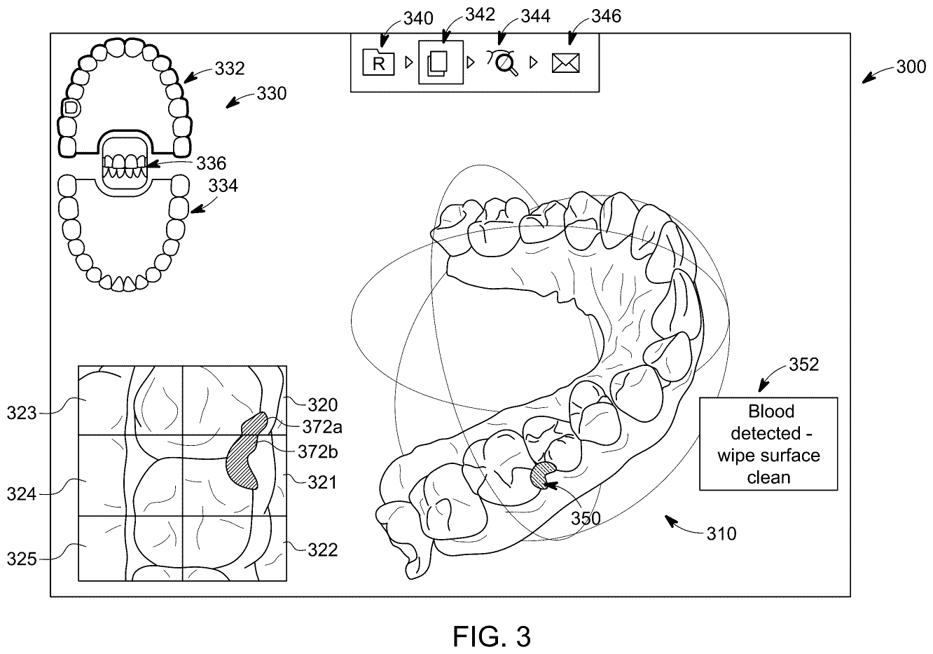

FIG. 3 illustrates a view of a graphical user interface 300 for an intraoral scan application that includes a 3D surface 310 and one or more 2D images 320-325 showing a current field of view (FOV) of an intraoral scanner, in accordance with embodiments of the present disclosure. The 3D surface 310 is generated by registering and stitching together multiple intraoral scans captured during an intraoral scanning session. As each new intraoral scan is generated, that scan is registered to the 3D surface and then stitched to the 3D surface. Accordingly, the 3D surface becomes more and more accurate with each intraoral scan, until the 3D surface is complete. A 3D model may then be generated based on the intraoral scans. In some embodiments, the multiple images 320-325 are combined into a combined image. In some embodiments, a single image is used (e.g., an image generated by one of multiple cameras of an intraoral scanner). In some embodiments, multiple images are used, each of which has been generated by a different camera. In some embodiments, processing logic determines which camera's images to present in the user interface. The selected camera may be change during intraoral scanning.

The 2D color images 320 and 321 show that blood 372A-B has pooled at a portion of multiple teeth. As a result, data for the obscured portions of the teeth from the intraoral scans were not used to generate the 3D surface 310. As shown, the 3D surface 310 includes a void 350 corresponding to the region of the teeth obscured by the blood 372A-B. In embodiments, processing logic may detect the blood 372A-B, determine that an amount of the blood exceeds a threshold, output notice 352 indicating that excess blood (or saliva) has been detected, and/or recommend that the doctor clear the blood away.

In one embodiment, as shown, a scan segment indicator 330 may include an upper dental arch segment indicator 332, a lower dental arch segment indicator 334 and a bite segment indicator 336. While the upper dental arch is being scanned, the upper dental arch segment indicator 332 may be active (e.g., highlighted). Similarly, while the lower dental arch is being scanned, the lower dental arch segment indicator 334 may be active, and while a patient bite is being scanned, the bite segment indicator 336 may be active. A user may select a particular segment indicator 332, 334, 336 to cause a 3D surface associated with a selected segment to be displayed. A user may also select a particular segment indicator 332, 334, 336 to indicate that scanning of that particular segment is to be performed. Alternatively, processing logic may automatically determine a segment being scanned, and may automatically select that segment to make it active.

The GUI may further include a task bar with multiple modes of operation or phases of intraoral scanning. Selection of a patient selection mode 340 may enable a doctor to input patient information and/or select a patient already entered into the system. Selection of a scanning mode 342 enables intraoral scanning of the patient's oral cavity. After scanning is complete, selection of a post processing mode 344 may prompt the intraoral scan application to generate one or more 3D models based on intraoral scans and/or 2D images generated during intraoral scanning, and to optionally perform an analysis of the 3D model(s). Examples of analyses that may be performed include analyses to detect areas of interest, to assess a quality of the 3D model(s), and so on. Once the doctor is satisfied with the 3D models, they may generate orthodontic and/or prosthodontic prescriptions. Selection of a prescription fulfillment mode 346 may cause the generated orthodontic and/or prosthodontic prescriptions to be sent to a lab or other facility to cause a prosthodontic device (e.g., a crown, bridge, denture, etc.) or orthodontic device (e.g., an orthodontic aligner) to be generated.

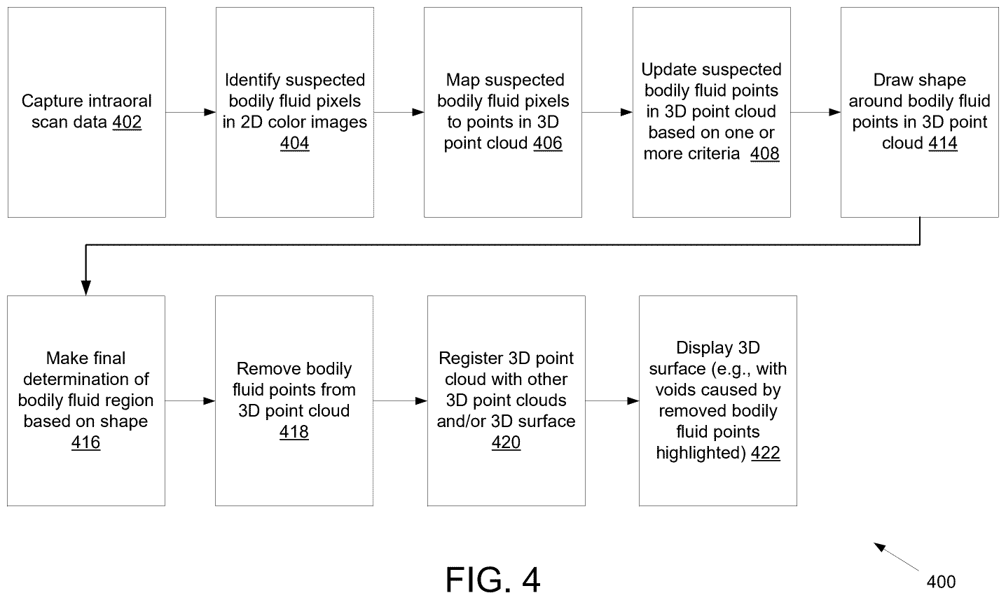

FIGS. 4-8B illustrate methods associated with intraoral scanning as well as identification and processing of bodily fluids in intraoral scans generated during the intraoral scanning. The methods may be performed by processing logic that comprises hardware (e.g., circuitry, dedicated logic, programmable logic, microcode, etc.), software (such as instructions run on a processing device), or a combination thereof. Various embodiments may be performed by processing logic executing on computing device 105 of FIG. 1. Additionally, or alternatively, operations of the methods may be performed by a processing device of the intraoral scanner 150. For example, the intraoral scanner 150 may determine 3D points from sets of images, may determine which 3D points represent bodily fluids, may filter out the points that represent bodily fluid, etc. before sending intraoral scan data to computing device 105. Alternatively, the computing device 105 may receive the images from the intraoral scanner 150, and may perform one or more such operations. In some embodiments, the intraoral scanner 150 and processing device 105 may split the operations performed to determine 3D points and/or to identify bodily fluid points, such that some of the operations are performed at the intraoral scanner 150 and other of the operations are performed at the computing device 105. The methods may be performed in real-time or near real-time as intraoral scans are generated by a scanner and/or received from the scanner.

FIG. 4 illustrates a flow diagram for a method 400 of identifying and removing representations of bodily fluids in intraoral scan data, in accordance with embodiments of the present disclosure. At block 402 of method 400, an intraoral scanner captures intraoral scan data. In embodiments, the intraoral scanner may send the intraoral scan data to a computing device over a wired or wireless connection.

The captured intraoral scan data may include one or more first sets of 2D images captured using structured light projection. Each image in a first set of images may be generated by a different camera of the intraoral scanner. Each of the cameras may have a unique field of view, a unique position in the intraoral scanner, a unique orientation, and so on. The intraoral scanner may be configured such that the fields of view of multiple cameras overlap. This may enable multiple cameras to generate images of the same portions of a dental site, but from different perspectives. In embodiments, one or more structured light projectors of the intraoral scanner project a structured light pattern onto a dental site. Each of the images in a set of images may capture features of the projected structured light pattern. Processing logic of the intraoral scanner and/or computing device may then determine which captured features in different images correspond to the same projected features of the structured light pattern (e.g., may solve a correspondence problem between the images). From the solved correspondence problem, a three dimensional position of some or all captured features of the structured light pattern may be determined, resulting in a 3D point cloud.

The captured intraoral scan data may additionally include one or more second sets of images (e.g., 2D color images generated under white light such as unstructured white light). The intraoral scanner may alternate between capturing images under structured light conditions to determine 3D data of a scanned surface and capturing images under unstructured (e.g., white light) conditions to determine color information about the scanned surface. Accordingly, each first set of images generated under structured light conditions may correspond to a second set of images generated under unstructured and/or white light conditions. The first set of images generated under structured light conditions may be captured close in time to the second set of images generated under unstructured and/or white light conditions. Accordingly, the first set of images and second set of images (e.g., white light images and structured light images) may be taken from the same, or approximately the same, position of the intraoral scanner relative to the scanned surface.

At block 404, processing logic of the intraoral scanner and/or computing device identifies suspected bodily fluid pixels in a second set of images (e.g., a set of 2D color images) of the generated intraoral scan data. In some embodiments, the second set of images are not color images, and are instead monochromatic images (e.g., black and white images), NIR images, images generated under unstructured light of one or more wavelengths, and so on. In some embodiments, suspected bodily fluid pixels are determined by processing each of the images in the second set of images (e.g., 2D color images or other images generated under non-structured light conditions) using a trained machine learning model (e.g., such as a neural network). Examples of neural networks that may be used include an encoder-decoder architecture, a u-net architecture, or other neural network architecture. The machine learning model may output a mask (e.g., a segmentation mask) identifying, for each pixel, a probability that the pixel depicts a bodily fluid. The machine learning model (or one or more other machine learning models) may also output other dental classification probabilities for the pixels, such as probabilities of the pixels depicting teeth, gingiva, excess material, moving tissue, foreign objects, and so on. Accordingly, in some embodiments multiple masks may be output by one or more trained machine learning models, each of which may provide different dental object classifications. In an example, one mask may identify pixels representing teeth and pixels representing gingiva, and another mask may identify pixels representing bodily fluids and pixels not representing bodily fluids. Accordingly, a pixel may be classified as a tooth with bodily fluid, as gingiva with bodily fluid, as a tooth without bodily fluid, as gingiva without bodily fluid, and so on in one example.

In embodiments, separate machine learning models are used to detect saliva and blood. Saliva and blood may have different optical characteristics, and may each be detected using a dedicated machine learning model that has been trained to identify that particular class of bodily fluid. Alternatively, a single machine learning model may be trained to identify both saliva and blood. It should be understood that the discussion above and below with relation to detection and handling of bodily fluid pixels, points, regions, etc. covers just blood, just saliva, a combination of blood and saliva, and/or other types of bodily fluids such as puss.

At block 406, processing logic of the intraoral scanner and/or the computing device maps the suspected bodily fluid pixels to points in the 3D point cloud generated from a set of images of the scan data that were generated using structured light projection. Processing logic may determine pixels of the 2D color images that correspond to pixels of the images generated using structured light projection (e.g., that depict captured features of a projected light pattern). In some embodiments, pixels of the 2D color images are mapped to the same pixels of the images generated using structured light projection by the same cameras. In some embodiments, a relative movement of the intraoral scanner to the dental site between the generation of the 2D color images and the images generated using structured light projection is determined or estimated, and the pixels of the 2D color images are mapped to pixels of the images generated using structured light projection based on the relative movement.

By mapping the second set of images (e.g., the set of color 2D images) to the first set of images (e.g., the set of images generated using structured light projection), the probabilities of pixels of the second set of images depicting one or more classes of dental object (e.g., of depicting bodily fluid) may also be mapped to pixels in the corresponding first set of images generated using structured light projection. Each of the captured features of the light pattern in each images of the first set of images may be assigned one or more probabilities (e.g., a probability of depicting a bodily fluid, a probability of depicting a tooth, a probability of depicting gingiva, etc.) from the mapping. Since the correspondence problem has been solved for the first set of images generated using structured light projection, the probabilities of the pixels representing one or more classes of dental objects may be mapped to the 3D points based on the determined solution to the correspondence problem.

As previously indicated, one or more of the 3D points of a generated 3D point cloud may be determined from multiple images of a set of images. Each of those images may have one or more pixels that map to one or more of the 3D points, and each of those pixels may have its own associated probabilities (i.e., of depicting one or more dental object classes). Accordingly, some 3D points may have multiple probabilities assigned to it. In an example, a 3D point that was determined from 3 images may have three different probabilities of that 3D point representing blood, of that 3D point representing saliva, of that 3D point representing a tooth, of that 3D point representing gingiva, and so on. Processing logic may combine the multiple probabilities into a single combined probability score. Such combination of multiple probabilities may be based on a weighted or unweighted averaging of the probabilities associated with that 3D point. Alternatively, other statistical techniques may be used to determine the combined probability, such as determining a median probability value. In some embodiments, a voting algorithm is used to generate the combined probability score, or to otherwise determine suspect bodily fluid points. In embodiments, 3D points having a probability of depicting a bodily fluid that is above a probability threshold are identified as suspected bodily fluid points. Similarly, 3D points having a probability of depicting a tooth that exceeds a threshold may be identified as tooth points, 3D points having a probability of depicting a gingiva that exceeds a threshold may be identified as gingival points, and so on. There may be a certain rate of error for the probabilities determined for pixels by the machine learning model. However, by using dental class probabilities from multiple images for 3D points, the individual errors associated with individual images may be reduced and the accuracy of the dental class probabilities for those 3D points may be improved.

At block 408, processing logic of the intraoral scanner and/or computing device may update suspected bodily fluid points based on one or more criteria. In one embodiment, a criterion that is used to confirm or negate suspected bodily fluid points is a density or amount of surrounding bodily fluid points. In some embodiments, the images generated by the intraoral scanner have sparsely populated points. For example, if a projected light pattern that is captured in images is a pattern of sparse dots, then the images have sparse information for captured features of the light pattern. Accordingly, there may be insufficient information to confirm or negate a suspected bodily fluid point from a single set of images. In some embodiments, a moving window of 3D point dental class probability information is determined. The moving window may include a record of 3D point dental class probabilities (e.g., masks) for one or more 3D point clouds generated prior to a current 3D point cloud under process as well as one or more 3D point clouds generated after the current 3D point cloud under process. The moving window may extend, for example, a few (e.g., 1-3) milliseconds into the future and/or past. A moving window for a current 3D point cloud may be based in part on one or more 3D point clouds generated from sets of images captured after the set of images used to generate the current 3D point cloud. Accordingly, there may be a delay in performance of the operations of block 408 until those additional sets of images have been generated and processed.

For each suspected bodily fluid point in the 3D point cloud under process, processing logic may determine an amount or density of proximate or surrounding suspected bodily fluid points. In one embodiment, processing logic determines an amount of other suspected bodily fluid points within a threshold distance (e.g., 0.5 mm, 1 mm, 1.5 mm, etc.) from a suspected bodily fluid point in question. The magnitude of the threshold distance may be optimized to a specific domain and/or device, and the provided values are merely examples. If the number or density of proximate or surrounding suspected bodily fluid points meets or exceeds a threshold, then the suspected bodily fluid point may be confirmed as a bodily fluid point. The threshold number of points may be optimized to a specific domain and/or device. Example threshold numbers of points include 5 points, 10 points, 15 points, 20 points, 25 points, 30 points, 100 points, and so on. If the number or density of proximate or surrounding suspected bodily fluid points is below the threshold, then the suspected bodily fluid point may be determined not to be a bodily fluid point. In some embodiments, statistics of suspected bodily fluid points are gathered over time. Clustering may then be performed to identify clusters of suspected bodily fluid points (e.g., points having a probability of being a bodily fluid that is greater than a threshold) that satisfy one or more criteria, confirming those suspected bodily fluid points in the clusters as true bodily fluid points. In some embodiments, a clustering algorithm such as density-based spatial clustering of applications with noise (DBSCAN) is used for this purpose.

When a bodily fluid accumulates in a person's mouth, that bodily fluid will form as a pool, one or more bubbles, and/or other physical arrangement that will be represented in multiple pixels or points in a 3D point cloud. Accordingly, bodily fluid points in a 3D point cloud should be proximate to other bodily fluid points. Suspected bodily fluid points that are not immediately proximate to other bodily fluid points may not actually depict a bodily fluid. By using density or amount of suspected bodily fluid points around a suspected bodily fluid point in question as a criterion for confirming the suspected bodily fluid point, the accuracy of the bodily fluid detection may be increased.

At block 414, processing logic of the intraoral scanner and/or computing device may perform one or more operations to update bodily fluid points. In one embodiment, for each confirmed bodily fluid point, processing logic draws a shape around or boundary the bodily fluid point in the 3D point cloud. The shape may be a 2D shape such as a circle or ellipse, or may be a 3D shape such as a sphere, hemisphere, or other rounded shape. The shape may be a set size, and may be centered on the bodily fluid point. For example, the shape may have a size of 0.5 mm, 1 mm, 1.5 mm, or other size. The size and/or shape of the boundary may be optimized to a specific domain and/or device. In some embodiments, the shapes/boundaries drawn around the bodily fluid points are combined, and a superposition of the shapes/boundaries may create general, organic or random shapes.

At block 416, processing logic of the intraoral scanner and/or computing device may make a final determination of a bodily fluid region (e.g., including multiple bodily fluid points). In embodiments, any points that are within the drawn shape(s) may be updated so that they are also classified as bodily fluid points. By using the drawn shape(s) to update bodily fluid point classifications, processing logic may ensure that in general regions of bodily fluids are contiguous (e.g., avoiding a situation where there are points classified as not bodily fluid between other points classified as bodily fluid points, which corresponds to how such bodily fluids form in a person's mouth in real life. Accordingly, use of the shapes around classified bodily fluid points to update bodily fluid point classifications further increases an accuracy of bodily fluid detection.

At block 418, processing logic of the intraoral scanner and/or computing device may remove the bodily fluid points from the 3D point cloud. Alternatively, processing logic may simply ignore or filter out the bodily fluid points without actually removing those points from the 3D point cloud. If the operations of blocks 404-418 were performed by an intraoral scanner, then the 3D point cloud may be provided to a computing device for further processing. Alternatively, the captured intraoral scan data 402 may have been transmitted to a computing device, and the computing device may have performed the operations of blocks 404-418.

At block 420, processing logic may register and stitch the 3D point cloud with other 3D point clouds and/or a generated 3D surface (e.g., that has been generated by registering and stitching together multiple 3D point clouds (each associated with or constituting a discrete intraoral scan). The bodily fluid points of the 3D point cloud may not be used in registering and/or stitching the 3D point cloud to the other 3D point clouds and/or 3D surface (e.g., 3D mesh). Accordingly, the 3D surface may include a void corresponding to the detected bodily fluid region (e.g., to the bodily fluid points).

At block 422, processing logic may display the generated 3D surface. The shown 3D surface may include one or more voids caused by the removed bodily fluid points. In some embodiments, the voids may be emphasized or highlighted on a display. This may draw a dental practitioner's attention to the voids. The user interface may also output a notice or alert to the display when a threshold amount of bodily fluid and/or suspected bodily fluid has been detected (e.g., when a threshold number of bodily fluid points has been detected, when a bodily fluid region having a threshold size has been detected, etc.). The alert may include a recommendation for the dental practitioner to wipe away or otherwise remove the bodily fluid from the patient's mouth.

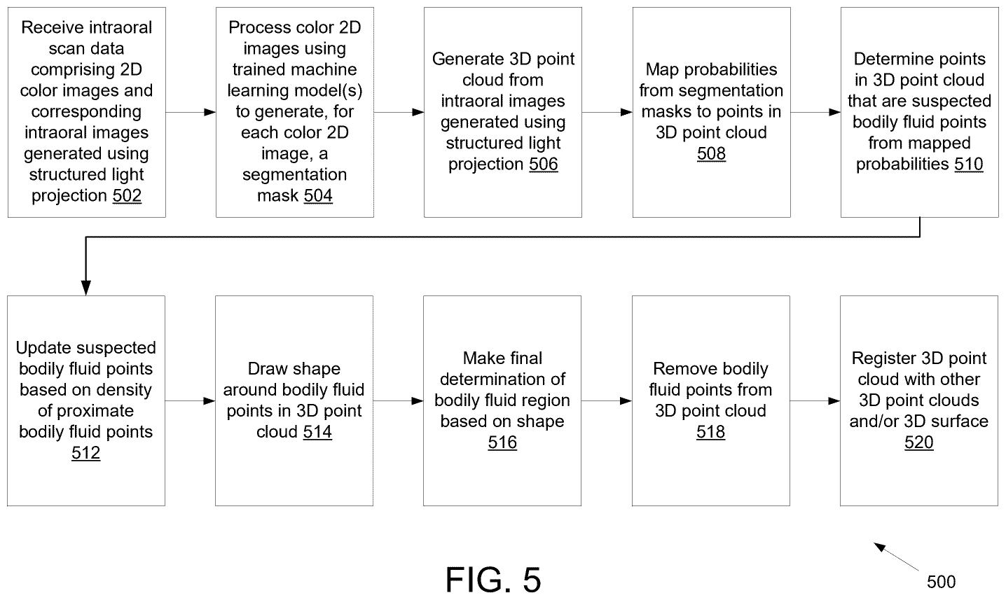

FIG. 5 illustrates a flow diagram 500 for a method of identifying and removing representations of bodily fluids in intraoral scan data, in accordance with embodiments of the present disclosure. At block 502 of method 500, a computing device receives intraoral scan data comprising a first set of images generated using structured light projection and a corresponding second set of images (e.g., set of 2D color images).

At block 504, processing logic processes the second set of images using one or more trained machine learning models to generate, for each image in the second set of images, a mask such as a segmentation mask. The mask generated for an image may include, for each pixel of the image, a probability of that pixel being a bodily fluid pixel (e.g., a blood pixel or a saliva pixel).

At block 506, processing logic generates a 3D point cloud from the first set of intraoral images that were generated using structured light projection. Each image in the first set of images may have been generated by a different camera at a same point in time. The 3D point cloud may be generated by solving a corresponding problem, where the solution provides triangulation data that indicates depths for each of the 3D points.

At block 508, processing logic maps probabilities from the masks associated with the images of the second set of images to points in the 3D point cloud.

At block 510, processing logic determines points in the 3D point cloud that are suspected bodily fluid points from the mapped probabilities. This may include determining an average probability, a median probability, or some other statistical combination of probabilities for each 3D point cloud based on the probabilities of pixels mapped to those 3D points.

At block 512, processing logic updates suspected bodily fluid points based a density of proximate suspected bodily fluid points (e.g., optionally using a clustering algorithm). The proximate suspected bodily fluid points may be from the current 3D point cloud and/or one or more additional 3D point clouds generated from intraoral scan data captured before and/or after the intraoral scan data used to generate the current 3D point cloud in embodiments.

At block 514, processing logic draws a shape around the bodily fluid points in the 3D point cloud. The shape may be a 2D shape such as a circle or ellipse, or may be a 3D shape such as a sphere, hemisphere, or other rounded shape.

At block 516, processing logic makes a final determination of a bodily fluid region (e.g., including multiple bodily fluid points). In embodiments, any points that are within the drawn shape may be updated so that they are also classified as bodily fluid points.

At block 518, processing logic removes the bodily fluid points from the 3D point cloud. Alternatively, processing logic may simply ignore or filter out the bodily fluid points without actually removing those points from the 3D point cloud.

At block 520, registers and stitches the 3D point cloud with other 3D point clouds and/or a generated 3D surface or model (e.g., that has been generated by registering and stitching together multiple 3D point clouds (each associated with or constituting a discrete intraoral scan). The bodily fluid points of the 3D point cloud may not be used in registering and/or stitching the 3D point cloud to the other 3D point clouds and/or 3D surface (e.g., 3D mesh). Accordingly, the 3D surface may include a void corresponding to the detected bodily fluid region (e.g., to the bodily fluid points).

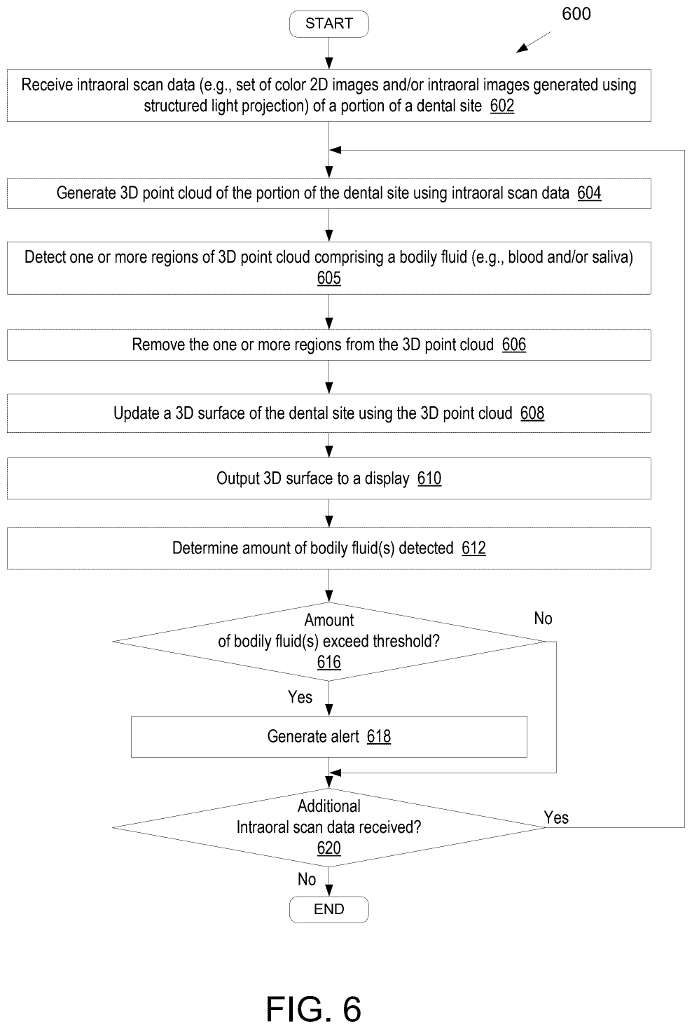

FIG. 6 illustrates a flow diagram for a method 600 of addressing bodily fluids in intraoral scan data, in accordance with embodiments of the present disclosure. At block 602 of method 600, processing logic receives intraoral scan data of a portion of a dental site. The intraoral scan data may include a first set of images generated using structured light projection (where for each set of images each image may have been generated by a different camera of an intraoral scanner) and a second set of images (e.g., set of color 2D images, where each image may have been generated by a different camera of the intraoral scanner).

At block 604, processing logic generates a 3D point cloud of the portion of the dental site using the intraoral scan data. In some embodiments, the 3D point cloud is determined by performing triangulation between corresponding points captured in different images of a first set of intraoral images. Such triangulation may be performed by solving a correspondence problem, as discussed herein above.

At block 605, processing logic determines one or more regions of the 3D point cloud comprising a bodily fluid or suspected bodily fluid. Suspected bodily fluid identification is discussed in greater detail above. In some embodiments, different operations are performed to identify blood and to identify saliva (e.g., saliva bubbles). Alternatively, the same set of operations may be performed to identify both blood and saliva. Operations may also be performed to identify other bodily fluids, such as puss. In some embodiments, the one or more regions comprising a bodily fluid or suspected bodily fluid are detected by inputting the 3D point cloud, or data for the 3D point cloud, into one or more trained machine learning models, which may output dental object classifications (e.g., a blood classification, a saliva classification, a tooth classification, a gingiva classification, etc.) for the 3D points of the 3D point cloud. In some embodiments, the intraoral images from one or more sets of intraoral images are input into one or more trained machine learning models, which output dental object classifications for pixels in the intraoral images, which may be mapped to points on the 3D point cloud. In some embodiments, the 2D images from a second set images are input into one or more trained machine learning models, which output dental object classifications for pixels in the images. Pixels in the images may then be mapped to pixels in the intraoral images of the first set of images generated using structured light projection, which may be mapped to 3D points in the 3D point cloud.

In some embodiments, further operations may be performed to detect regions in the 3D point cloud that comprise or depict bodily fluids and/or suspected bodily fluids. Such operations may include, for example, generating a statistical or other combination of dental object classifications from multiple images having pixels that map to the same 3D point, determining whether 3D points satisfy one or more bodily fluid classification criteria, drawing boundaries or shapes around 3D points classified as bodily fluid points and reclassifying nearby 3D points in the boundaries or shapes as also being bodily fluid points, and so on. Examples of such operations are described above with reference to FIGS. 4-5.

At block 606, processing logic removes the one or more regions classified as bodily fluid regions from the 3D point cloud. Alternatively, rather than removing such bodily fluid 3D points, processing logic may simply filter out or ignore those 3D points in one or more further operations.

At block 608, processing logic updates a 3D surface of the dental site using the 3D point cloud. The bodily fluid regions from the 3D point cloud may not be added to the 3D surface in embodiments (e.g., due to those points being removed or filtered out). Updating the 3D surface may include registering the 3D point cloud to the 3D surface, and stitching the 3D point cloud to the 3D surface, as discussed in greater detail above. If no 3D surface had yet been generated, then a 3D surface may be generated by registering and stitching the 3D point cloud to one or more other 3D point clouds for which operations 602-606 have been performed.

At block 610, processing logic may output the 3D surface to a display. Since the bodily fluid regions were not included in the 3D surface, the 3D surface may have voids that correspond to the bodily fluid regions. The void may be an indication to a dental practitioner to generate additional intraoral scans of the area of the 3D surface having the void. In some embodiments, the void caused by the bodily fluid may be highlighted or emphasized on the 3D surface and/or in the display to call a dental practitioner's attention to the void. The void may be accompanied by a label or flag indicating a cause of the void (e.g., blood, saliva, bodily fluid generally, etc.). In embodiments, one or more viewfinder images may also be displayed. The viewfinder images may be, or be based on, one or more of the color 2D images in embodiments. The identified bodily fluid pixels may additionally or alternatively be highlighted or otherwise emphasized in the viewfinder images. In an example, blood may be highlighted in bright red, saliva may be emphasized by increasing an intensity or brightness (e.g., to make it appear as though the saliva region is glowing), and/or other visual effects may be used to call out the bodily fluid regions.

In some embodiments, at block 612 processing logic determines an amount of detected and/or suspected bodily fluid (or bodily fluids). This may include separately determining an amount of blood that has been detected and/or suspected and an amount of saliva that has been detected and/or suspected in some embodiments. Alternatively, a determined amount of bodily fluid may be for a single type of bodily fluid, or may be a combined total for an aggregate of different types of bodily fluids that have been detected. The amount of bodily fluid detected may be determined based on quantifying a number of 3D points in 3D point clouds classified as bodily fluid points, by measuring a size of a void in a 3D surface caused by a bodily fluid region, and/or other measurement or quantification techniques. In some embodiments, an amount of bodily fluid detected and/or suspected is determined for each 3D point cloud. Processing logic may then compare the amount of bodily fluid that has been detected and/or suspected over time, and may determine whether an amount of bodily fluid is steady, is increasing, is decreasing, etc. In some embodiments, an amount of bodily fluid detected and/or suspected in 3D point clouds is integrated over time (e.g., based on time stamps of sets of intraoral images and/or color images used to generate 3D point cloud and/or classify points on 3D point cloud) to determine a rate of change of bodily fluid amount. In some embodiments, an amount of bodily fluid detected and/or suspected in the 3D surface is integrated over time to determine a rate of change of bodily fluid amount.

At block 616, processing logic determines whether a detected and/or suspected amount of bodily fluid exceeds a threshold. This may also include determining whether a rate of change of the bodily fluid exceeds a threshold, or using a determined rate of change of the bodily fluid amount to predict a future time point at which the bodily fluid amount will exceed a threshold. If the amount of bodily fluid that is detected and/or suspected exceeds a bodily fluid amount threshold, a rate of change of the bodily fluid exceeds a rate of change threshold, and/or a predicted amount of bodily fluid exceeds a bodily fluid amount threshold, the method may continue to block 618. Otherwise the method proceeds to block 620.

At block 618, processing logic may generate an alert. The alert may include an audible alert, a visual alert (e.g., a prompt or pop-up notice in a GUI), a tactile alert (e.g., using haptics in the scanner), and so on. The alert may indicate that an amount of bodily fluid (e.g., an amount of blood and/or saliva) is excessive and/or is reducing a scan accuracy, that the dental practitioner should clear away the bodily fluid, that the amount of blood and/or saliva is accumulating quickly, and/or other messages. Responsive to receiving the alert, a dental practitioner should wipe away, or otherwise clear the detected bodily fluid from the patient's mouth (e.g., from the dental site being scanned). Subsequently, new intraoral scan data of the dental site will be of a cleaned dental site that lacks the bodily fluid, and will be more accurate. This additional intraoral scan data may be registered and stitched to the 3D model to fill in the voids in the 3D surface caused by the previously detected bodily fluid.

At block 620, processing logic determines whether additional scan data has been received. If additional scan data is received, the method returns to block 604, and the sequence of operations may be repeated for the new intraoral scan data. Method 600 may continue until scanning is complete. Scanning may be complete once an accurate 3D model has been generated that lacks voids caused by bodily fluids or for which such voids are smaller than a threshold size in some embodiments.

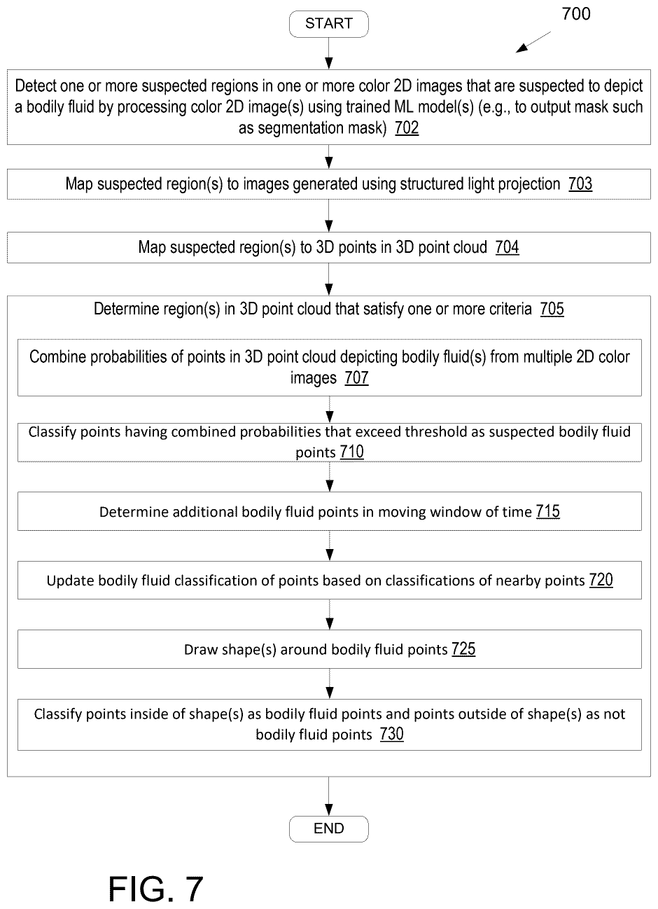

FIG. 7 illustrates a flow diagram for a method 700 of identifying bodily fluids in intraoral scan data, in accordance with embodiments of the present disclosure. In some embodiments, the operations of method 700 are performed at block 605 of method 600. At block 702 of method 700, processing logic detects one or more suspected regions in one or more color 2D images or other 2D images. Suspected regions are regions that are suspected to correspond to a particular dental object class. In embodiments, suspected regions are regions that are suspected to depict a bodily fluid (e.g., blood or saliva). Alternatively, suspected regions are regions that are suspected to depict some other dental class that is to be filtered out, such as moving tissue (e.g., tongue, cheeks, etc.), foreign objects (e.g., dental tools, hands, fingers, etc.), excess tissue, and so on. In embodiments, suspected regions in the one or more 2D color images or other 2D images are determined by processing each of the 2D color images or other 2D images from a set of 2D color images (or other 2D images) using a trained machine learning model. The trained machine learning model may output one or more masks, where an output mask may be a segmentation mask and/or may provide probabilities of pixels representing one or more bodily fluids (e.g., a probability of representing blood, a probability of representing saliva, etc.). Images generated using structured light projection may include less data than images generated using uniform white light (e.g., color 2D images). Accordingly, processing of color images using the trained machine learning model may be more accurate than processing images generated using structured light projection with the machine learning model.

At block 703, processing logic maps suspected regions in the color 2D images or other 2D images to the images generated using structured light projection. Each color 2D image or other 2D image of a set of color 2D images (or other 2D images) may correspond to an image of the set of images generated using structured light projection. Based on such correspondence, a mask for a color 2D image or other 2D image may be transformed into a map for a corresponding image generated using structured light projection.

At block 704, the suspected region or regions in the images generated using structured light projection are mapped to 3D points in a 3D point cloud. The 3D point cloud may have been generated using multiple images generated using structured light projection, where correspondence between points in the different images provides 3D coordinates for points in the 3D point cloud. Suspected regions may be made up of suspected bodily fluid pixels, and each suspected bodily fluid pixel may correspond to a 3D point in the 3D point cloud.

At block 705, processing logic determines one or more regions in the 3D point cloud that satisfy one or more criteria. The criteria may be bodily fluid point verification criteria that, if satisfied, confirm a suspected bodily fluid point as a true bodily fluid point.

One or more points in the 3D point cloud may be associated with pixels in multiple images, and each such pixel from an image may have a different probability of that pixel depicting a bodily fluid associated with it. Accordingly, a 3D point may have multiple probabilities of depicting a bodily fluid associated with it. At block 707, for each point in the 3D point cloud processing logic determines a combined probability score that represents a probability of that 3D point depicting a bodily fluid. The combined probability score may be an average, a weighted average, a median, or other statistical value generated from the multiple probabilities associated with a point.

At block 710, processing logic may classify points having combined probabilities that exceed a threshold as suspected bodily fluid points. At block 715, processing logic may determine additional bodily fluid points that have accumulated from intraoral scan data collected within a moving window of time. Such additional bodily fluid points may include bodily fluid points from 3D point clouds generated from one or more sets of images captured prior to a current set of images used to generate a current 3D point cloud. Such additional bodily fluid point may also or alternatively include bodily fluid points from 3D point clouds generated from one or more sets of images captured after the current set of images used to generate the current 3D point cloud. Each of the 3D points clouds that precede or follow the current 3D point cloud may have been processed in a similar manner as described above to determine suspected bodily fluid points in those 3D point clouds. Bodily fluid points should not occur in isolation. Accordingly, processing logic may determine a density of points around suspected bodily fluid points, and then determine whether to confirm suspected bodily fluid points or reject suspected bodily fluid points based on the density of surrounding bodily fluid points. Accordingly, at block 720 processing logic may update a bodily fluid classification of points based on classifications of nearby points. For each suspected bodily fluid point, if a number of nearby bodily fluid points exceeds a threshold, then the suspected bodily fluid point may be confirmed as a bodily fluid point in an embodiment.

At block 725, processing logic may draw a shape (e.g., a circular shape) around each confirmed bodily fluid point. Each other point that is within the drawn shape but is not currently classified as a bodily fluid point may be updated to that it is reclassified as a bodily fluid point.

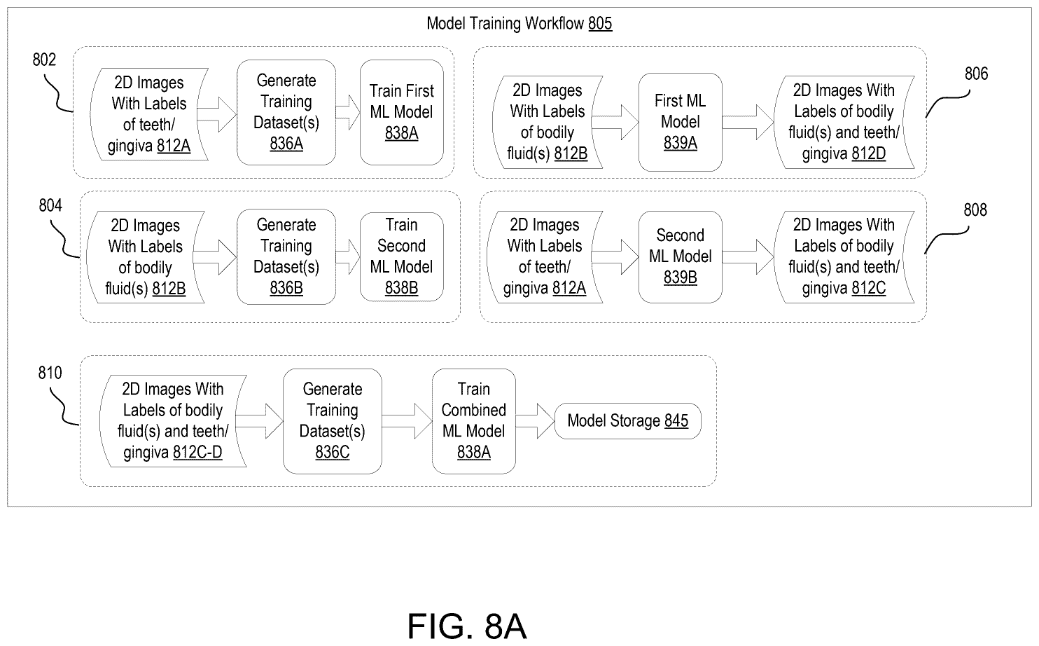

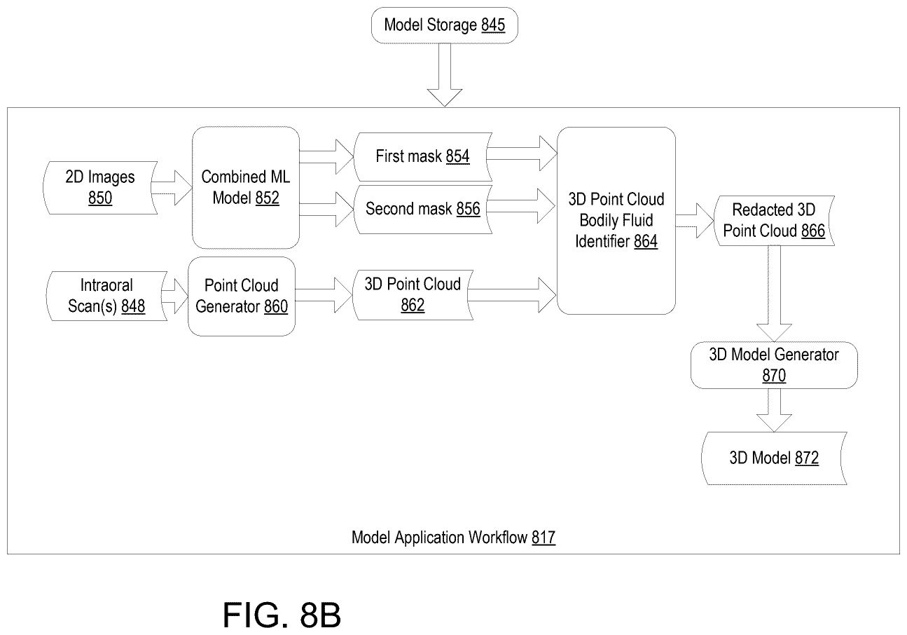

FIG. 8A illustrates a model training workflow 805 for training one or more machine learning models to identify bodily fluids and/or other dental object classifications in intraoral scan data, in accordance with an embodiment of the present disclosure. In embodiments, the model training workflow 805 may be performed at a server which may or may not include an intraoral scan application, and the trained models are provided to an intraoral scan application (e.g., on computing device 105 of FIG. 1), which may perform a model application workflow as described in FIG. 8B. The model training workflow 805 may be performed by processing logic executed by a processor of a computing device.

The model training workflow 805 is to train one or more machine learning models (e.g., deep learning models) to perform one or more classifying, segmenting, detection, recognition, image generation, prediction, parameter generation, etc. tasks for intraoral scan data (e.g., 3D scans, 3D point clouds, height maps, 2D color images, NIRI images, etc.) and/or 3D surfaces generated based on intraoral scan data.

Multiple different machine learning model outputs are described herein. Particular numbers and arrangements of machine learning models are described and shown. However, it should be understood that the number and type of machine learning models that are used and the arrangement of such machine learning models can be modified to achieve the same or similar end results. Accordingly, the arrangements of machine learning models that are described and shown are merely examples and should not be construed as limiting. Moreover, in some embodiments rules based logic may be used instead of, or in addition to, trained machine learning models to perform one or more of the operations described herein.

In embodiments, one or more machine learning models are trained to perform image classification to classify 2D color images (or other 2D images) of dental sites into one or more dental object classes. In some embodiments, different machine learning models are trained to detect different dental object classes. In some embodiments, one or more combined machine learning models are trained, which may share one or more layers, but generate different classification results. In an example, one or a few machine learning models may be trained, where the trained ML model is a single shared neural network that has multiple shared layers and multiple higher level distinct output layers, where each of the output layers outputs a different prediction, classification, identification, etc.

One type of machine learning model that may be used to perform some or all of the above asks is an artificial neural network, such as a deep neural network. Artificial neural networks generally include a feature representation component with a classifier or regression layers that map features to a desired output space. A convolutional neural network (CNN), for example, hosts multiple layers of convolutional filters. Pooling is performed, and non-linearities may be addressed, at lower layers, on top of which a multi-layer perceptron is commonly appended, mapping top layer features extracted by the convolutional layers to decisions (e.g. classification outputs). Deep learning is a class of machine learning algorithms that use a cascade of multiple layers of nonlinear processing units for feature extraction and transformation. Each successive layer uses the output from the previous layer as input. Deep neural networks may learn in a supervised (e.g., classification) and/or unsupervised (e.g., pattern analysis) manner. Deep neural networks include a hierarchy of layers, where the different layers learn different levels of representations that correspond to different levels of abstraction. In deep learning, each level learns to transform its input data into a slightly more abstract and composite representation. In an image recognition application, for example, the raw input may be a matrix of pixels; the first representational layer may abstract the pixels and encode edges; the second layer may compose and encode arrangements of edges; and the third layer may encode higher level shapes (e.g., teeth, lips, gums, blood, saliva, etc.). Notably, a deep learning process can learn which features to optimally place in which level on its own. The “deep” in “deep learning” refers to the number of layers through which the data is transformed. More precisely, deep learning systems have a substantial credit assignment path (CAP) depth. The CAP is the chain of transformations from input to output. CAPs describe potentially causal connections between input and output. For a feedforward neural network, the depth of the CAPs may be that of the network and may be the number of hidden layers plus one. For recurrent neural networks, in which a signal may propagate through a layer more than once, the CAP depth is potentially unlimited.

Training of a neural network may be achieved in a supervised learning manner, which involves feeding a training dataset consisting of labeled inputs through the network, observing its outputs, defining an error (by measuring the difference between the outputs and the label values), and using techniques such as deep gradient descent and backpropagation to tune the weights of the network across all its layers and nodes such that the error is minimized. In many applications, repeating this process across the many labeled inputs in the training dataset yields a network that can produce correct output when presented with inputs that are different than the ones present in the training dataset. In high-dimensional settings, such as large images, this generalization is achieved when a sufficiently large and diverse training dataset is made available.

In one embodiment, model training workflow 805 includes multiple sequences of operations 802-810. A first sequence of operations 802 may be performed to train a first machine learning model to classify and/or segment images into a first set of dental object classes (e.g., teeth and/or gingiva), and a second sequence of operations 804 may be performed to train a second machine learning model to classify and/or segment images into a second set of dental object classes (e.g., one or more of bodily fluid, not bodily fluid, blood, not blood, saliva, not saliva, etc.). A third sequence of operations 806 may be performed to label images using a first trained ML model 839A that has been trained to perform classification and/or segmentation of images into teeth and/or gingiva. A fourth sequence of operations 80 may be performed to label images using a second trained ML model 839B that has been trained to perform classification and/or segmentation of images into one or more bodily fluids. A fifth sequence of operations 810 may be performed to use the images labeled at the third and/or fourth sequence of operations 806, 808 to train a combined ML model that can output multiple sets of classifications (e.g., to classify pixels in images as gingiva or teeth and to also classify the pixels in the images as depicting or not depicting a bodily fluid). Since a pixel may be classified as both a tooth and a bodily fluid (e.g., representing a bodily fluid over a tooth), a standard ML model may not be able to generate such multi-faceted classifications.

Training a single neural network for multiple segmentation tasks (e.g., such as combined machine learning model 852) requires the existence of tagging of all pixels for all tasks. As this may make tagging prohibitively expensive, virtual tagging approaches are used in a Teacher-Student training approach in some embodiments. In such an approach, dedicated, per-task, segmentation networks are trained on all available tagged data that has been labeled for that task. As these networks are not restricted to real time performance, they may produce better segmentation results than a real-time multi-head network. By weighting the loss function towards manually tagged data the training procedure utilizes both data sources in a single training procedure in embodiments.

In first sequence of operations 802, a first training dataset is generated at block 836A containing hundreds, thousands, tens of thousands, hundreds of thousands or more 2D images of dental sites. The images may be labeled with labels (e.g., pixel-level labels) of teeth and of gingiva. In some embodiments, each individual tooth may be separately labeled in images (e.g., based on tooth number). In embodiments, up to millions of cases of patient dentition may be available for forming a training dataset, where each case may include various labeled images.

In one embodiment, generating one or more first training datasets 836A includes gathering one or 2D images with labels of teeth and/or gingiva 812A. One or more images and optionally associated probability maps or pixel/patch-level labels in the training dataset 812A may be resized in embodiments. For example, a machine learning model may be usable for images having certain pixel size ranges, and one or more image may be resized if they fall outside of those pixel size ranges. The images may be resized, for example, using methods such as nearest-neighbor interpolation or box sampling. The training dataset may additionally or alternatively be augmented. Training of large-scale neural networks generally uses tens of thousands of images, which are not easy to acquire in many real-world applications. Data augmentation can be used to artificially increase the effective sample size. Common techniques include random rotation, shifts, shear, flips and so on to existing images to increase the sample size.

To effectuate training, processing logic inputs the training dataset(s) 836A into one or more untrained machine learning models. Prior to inputting a first input into a machine learning model, the machine learning model may be initialized. Processing logic trains the untrained machine learning model(s) based on the training dataset(s) to generate one or more trained machine learning models that perform various operations as set forth above.

Training may be performed by inputting one or more of the images into the machine learning model one at a time at block 838A. Each input may include data from an image in a training data item from the training dataset.

The machine learning model processes the input to generate an output. An artificial neural network includes an input layer that consists of values in a data point (e.g., intensity values and/or height values of pixels in a height map). The next layer is called a hidden layer, and nodes at the hidden layer each receive one or more of the input values. Each node contains parameters (e.g., weights) to apply to the input values. Each node therefore essentially inputs the input values into a multivariate function (e.g., a non-linear mathematical transformation) to produce an output value. A next layer may be another hidden layer or an output layer. In either case, the nodes at the next layer receive the output values from the nodes at the previous layer, and each node applies weights to those values and then generates its own output value. This may be performed at each layer. A final layer is the output layer.

Processing logic may then compare the generated output to the known label that was included in the training data item. Processing logic determines an error (i.e., a classification error) based on the differences between the output probability map and/or label(s) and the provided probability map and/or label(s). Processing logic adjusts weights of one or more nodes in the machine learning model based on the error. An error term or delta may be determined for each node in the artificial neural network. Based on this error, the artificial neural network adjusts one or more of its parameters for one or more of its nodes (the weights for one or more inputs of a node). Parameters may be updated in a back propagation manner, such that nodes at a highest layer are updated first, followed by nodes at a next layer, and so on. An artificial neural network contains multiple layers of “neurons”, where each layer receives as input values from neurons at a previous layer. The parameters for each neuron include weights associated with the values that are received from each of the neurons at a previous layer. Accordingly, adjusting the parameters may include adjusting the weights assigned to each of the inputs for one or more neurons at one or more layers in the artificial neural network.

Once the model parameters have been optimized, model validation may be performed to determine whether the model has improved and to determine a current accuracy of the deep learning model. After one or more rounds of training, processing logic may determine whether a stopping criterion has been met. A stopping criterion may be a target level of accuracy, a target number of processed images from the training dataset, a target amount of change to parameters over one or more previous data points, a combination thereof and/or other criteria. In one embodiment, the stopping criteria is met when at least a minimum number of data points have been processed and at least a threshold accuracy is achieved. The threshold accuracy may be, for example, 70%, 80% or 90% accuracy. In one embodiment, the stopping criteria is met if accuracy of the machine learning model has stopped improving. If the stopping criterion has not been met, further training is performed. If the stopping criterion has been met, training may be complete. Once the machine learning model is trained, a reserved portion of the training dataset may be used to test the model.

In one embodiment, a first ML model is trained at block 838A to classify and/or segment input images into teeth and/or gingiva. Such segmentation and/or classification may be performed on a pixel by pixel basis, or on a patch level basis, where each patch may include a group of pixels.

In second sequence of operations 804, a second training dataset is generated at block 836B containing hundreds, thousands, tens of thousands, hundreds of thousands or more 2D images of dental sites. The images may be labeled with labels (e.g., pixel-level labels) of one or more types of bodily fluid (e.g., blood, saliva, etc.). Some images may be labeled with bodily fluid information but not tooth or gingiva classifications, while other images may be labeled with tooth or gingiva classifications but not bodily fluid information. Accordingly, different training datasets may be used to train the first ML model at block 838A and to train a second ML model at block 838B.

In one embodiment, generating one or more second training datasets 836B includes gathering one or 2D images with labels of bodily fluids 812B. One or more images and optionally associated probability maps or pixel/patch-level labels in the training dataset 812B may be resized in embodiments.

To effectuate training, processing logic inputs the training dataset(s) 836B into one or more untrained machine learning models. Prior to inputting a first input into a machine learning model, the machine learning model may be initialized. Processing logic trains the untrained machine learning model(s) based on the training dataset(s) to generate one or more trained machine learning models that perform various operations as set forth above.

Training may be performed by inputting one or more of the images, into the machine learning model one at a time at block 838B. Each input may include data from an image in a training data item from the training dataset. The ML model may generate an output, and an error may be determined based on the output and the known label for the image, and used to update the ML model. This may be repeated one or more times.

In one embodiment, a second ML model is trained at block 838B to classify and/or segment input images into regions containing one or more types of bodily fluid and regions not containing bodily fluids. Such segmentation and/or classification may be performed on a pixel by pixel basis, or on a patch level basis.

In third sequence of operations 806, images from the training dataset containing 2D images with labels of bodily fluids 812B may be processed using first trained ML model 839A to generate an updated training dataset 812D that includes labels of teeth and gingiva as well as labels of bodily fluids.

Similarly, in fourth sequence of operations 808, images from the training dataset containing 2D images with labels of teeth and gingiva 812A may be processed using second trained ML model 839B to generate an updated training dataset 812C that includes labels of teeth and gingiva as well as labels of bodily fluids.

In fourth sequence of operations 810, a new training dataset may be generated at block 836C, which may contain modified training dataset 812C and/or modified training dataset 812D. Images from the new training dataset may be input into a new combined ML model that includes two separate heads, where each head may include different higher level layers but may share the same lower level layers. One head of the combined ML model 838A may classify pixels of images into gingiva and teeth, and another head of the combined ML model 838A may classify pixels of images into one or more bodily fluids, or lack of bodily fluids.

Once one or more trained ML models are generated, they may be stored in model storage 845.

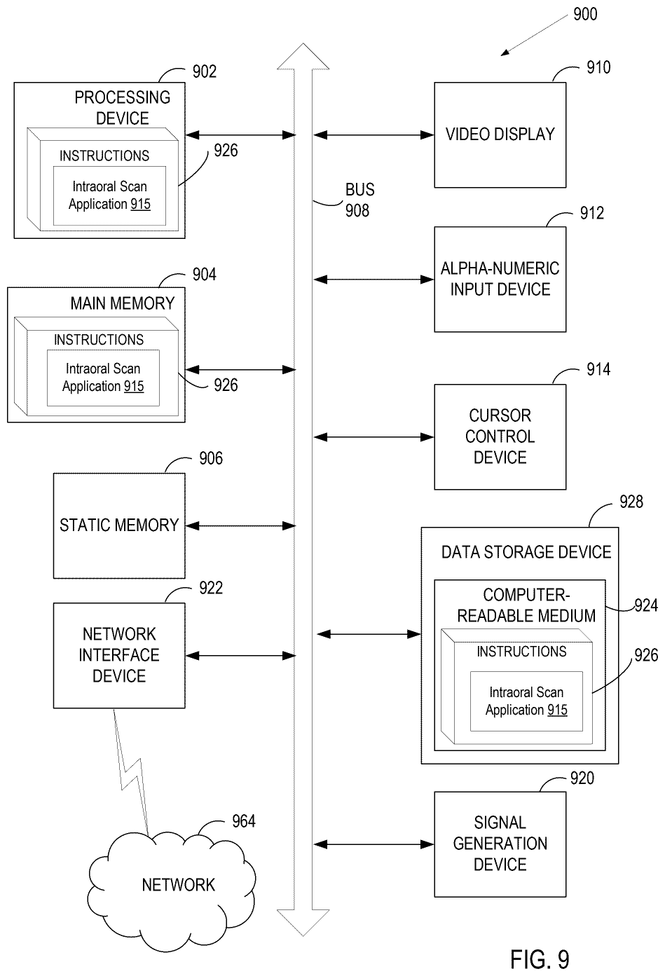

FIG. 8B illustrates a model application workflow 817 for using one or more machine learning models and/or other logic to identify bodily fluids and/or other dental object classifications in intraoral scan data, in accordance with an embodiment of the present disclosure. In embodiments, the model application workflow 817 may be performed at a server which may or may not include an intraoral scan application, at an intraoral scan application (e.g., on computing device 105 of FIG. 1), within an intraoral scanner, and so on. The model application workflow 817 may be performed by processing logic executed by a processor of a computing device and/or of an intraoral scanner. Model application workflow 817 may be implemented, for example, by an intraoral scanner 150 of FIG. 1, by an intraoral scan application 115 or other software and/or firmware executing on a processing device of computing device 900 shown in FIG. 9, or a combination thereof.

The model application workflow 817 is to apply the one or more trained machine learning models generated using the model training workflow 805 to perform the classifying, segmenting, detection, recognition, image generation, prediction, parameter generation, etc. tasks for intraoral scan data (e.g., 3D scans, 3D point clouds, height maps, 2D color images, NIRI images, etc.) and/or 3D surfaces generated based on intraoral scan data. One or more of the machine learning models may receive and process 3D data (e.g., 3D point clouds, 3D surfaces, portions of 3D models, etc.). One or more of the machine learning models may receive and process 2D data (e.g., 2D images, height maps, projections of 3D surfaces onto planes, etc.). In embodiments, a combined ML model 852 is added to model application workflow 817 from model storage 845.

For model application workflow 817, according to one embodiment, an intraoral scanner generates a sequence of intraoral scan data, each of which may include one more intraoral scans 848 (e.g., each including a set of images captured under structured light projection by a different camera of an intraoral scanner at a same time) and one or more sets of 2D color images 850 (e.g., each including a color 2D image generated by a different camera of the intraoral scanner at a same time).

A point cloud generator 860 may process each intraoral scan (e.g., each set of images generated using structured light projection) to generate a 3D point cloud 862. Processing the set of images may include performing triangulation between captured features in the images and solving a correspondence algorithm.

A combined ML model 852 may receive each image of the set of images 850. In embodiments, to minimize neural network execution time, a dual headed segmentation network is used (e.g., which may be a U-net). By sharing some of the weights with other neural networks, the computational load of bodily fluid detection is reduced so that the system may handle multiple segmentation tasks in real-time.

The combined ML model 852 may output multiple masks 854, 856 for each image of the set of images 850 that is processed. In an example, a first mask 854 may be a segmentation mask that segments in input image into one or more teeth and/or gingiva. In an example, a second mask 856 may be a mask that identifies pixels depicting a bodily fluid. Each mask may include one or more probabilities for each pixel of an input image, where each probability is a probability of a pixel belonging to a particular class. For example, each pixel of first mask 854 may include a probability of the pixel being gingiva and a probability of the pixel being a tooth. In another example, each pixel of second mask 856 may include a probability of the pixel being a bodily fluid pixel. Alternatively, each pixel of second mask 856 may include a first probability of the pixel being a blood pixel and a second probability of the pixel being a saliva pixel.

A 3D point cloud bodily fluid identifier 864 may receive the first mas 854 and second mask 856 for each image of a set of images, and may receive the 3D point cloud 862 generated from an intraoral scan associated with the set of images (e.g., that was generated close in time to when the set of images was generated). The 3D point cloud bodily fluid identifier may process the received data to identify bodily fluid points in the 3D point cloud. In embodiments, 3D point cloud bodily fluid identifier 864 performs one or more of the operations of method 700 to identify bodily fluid points. 3D point cloud bodily fluid identify may redact bodily fluid points from the 3D point cloud, and may output a redacted 3D point cloud 866.

A 3D model (or surface) generator 870 may register the redacted 3D point cloud with one or more other redacted 3D point clouds and/or with a 3D surface or model generated based on stitching together multiple 3D point clouds, and may stitch the redacted 3D point cloud to the other redacted 3D point clouds and/or 3D surface or model to generate a 3D model 872. The 3D model 872 may be output to a display for view by a patient and/or dental practitioner. The model application workflow 817 may be continuously performed on intraoral scan data as the intraoral scan data is generated during intraoral scanning. Bodily fluid regions may be identified on-the-fly during scanning, either real time or near-real time, so that generated 3D surfaces and/or models 872 may be generated with detected bodily fluids taken into account. Thus, during an intraoral scanning session a dental practitioner may see that one or more regions of a 3D surface are missing due to accumulated bodily fluids in a patient's mouth, and may remove those bodily fluids and continue scanning to fill in missing information corresponding to those regions that were covered by bodily fluids. In this manner, intraoral scanning accuracy may be improved, and the quality of 3D models generated based on intraoral scanning may be improved.

FIG. 9 illustrates a diagrammatic representation of a machine in the example form of a computing device 900 within which a set of instructions, for causing the machine to perform any one or more of the methodologies discussed herein, may be executed. In some embodiments, the machine may be connected (e.g., networked) to other machines in a Local Area Network (LAN), an intranet, an extranet, or the Internet. The machine may operate in the capacity of a server or a client machine in a client-server network environment, or as a peer machine in a peer-to-peer (or distributed) network environment. The machine may be a personal computer (PC), a tablet computer, a set-top box (STB), a Personal Digital Assistant (PDA), a cellular telephone, a web appliance, a server, a network router, switch or bridge, a computer operatively connected to an intraoral scanner (and part of an intraoral scanning system) or any machine capable of executing a set of instructions (sequential or otherwise) that specify actions to be taken by that machine. Further, while only a single machine is illustrated, the term “machine” shall also be taken to include any collection of machines (e.g., computers) that individually or jointly execute a set (or multiple sets) of instructions to perform any one or more of the methodologies discussed herein.

The example computing device 900 includes a processing device 902, a main memory 904 (e.g., read-only memory (ROM), flash memory, dynamic random access memory (DRAM) such as synchronous DRAM (SDRAM), etc.), a static memory 906 (e.g., flash memory, static random access memory (SRAM), etc.), and a secondary memory (e.g., a data storage device 928), which communicate with each other via a bus 908.

Processing device 902 represents one or more general-purpose processors such as a microprocessor, central processing unit, or the like. More particularly, the processing device 902 may be a complex instruction set computing (CISC) microprocessor, reduced instruction set computing (RISC) microprocessor, very long instruction word (VLIW) microprocessor, processor implementing other instruction sets, or processors implementing a combination of instruction sets. Processing device 902 may also be one or more special-purpose processing devices such as an application specific integrated circuit (ASIC), a field programmable gate array (FPGA), a digital signal processor (DSP), network processor, or the like. Processing device 902 is configured to execute the processing logic (instructions 926) for performing operations and steps discussed herein.

The computing device 900 may further include a network interface device 922 for communicating with a network 964. The computing device 900 also may include a video display unit 910 (e.g., a liquid crystal display (LCD) or a cathode ray tube (CRT)), an alphanumeric input device 912 (e.g., a keyboard), a cursor control device 914 (e.g., a mouse), and a signal generation device 920 (e.g., a speaker).

The data storage device 928 may include a machine-readable storage medium (or more specifically a non-transitory computer-readable storage medium) 924 on which is stored one or more sets of instructions 926 embodying any one or more of the methodologies or functions described herein. Wherein a non-transitory storage medium refers to a storage medium other than a carrier wave. The instructions 926 may also reside, completely or at least partially, within the main memory 904 and/or within the processing device 902 during execution thereof by the computer device 900, the main memory 904 and the processing device 902 also constituting computer-readable storage media.

The computer-readable storage medium 924 may also be used to store an intraoral scan application 950, which may correspond to similarly named intraoral scan application 115 of FIG. 1. The computer readable storage medium 924 may also store a software library containing methods that call intraoral scan application 950. While the computer-readable storage medium 924 is shown in an example embodiment to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing or encoding a set of instructions for execution by the machine and that cause the machine to perform any one or more of the methodologies of the present disclosure. The term “computer-readable storage medium” shall accordingly be taken to include, but not be limited to, solid-state memories, and optical and magnetic media.

The following exemplary embodiments are now described.

Embodiment 1: A method comprising: receiving intraoral scan data comprising one or more intraoral images of a portion of a dental site generated using structured light projection during intraoral scanning of the dental site; generating a three-dimensional (3D) point cloud of the portion of the dental site using the intraoral scan data; detecting one or more regions of the 3D point cloud comprising a bodily fluid; removing the one or more regions from the 3D point cloud; updating a 3D surface of the dental site using the 3D point cloud of the portion of the dental site; and outputting the 3D surface of the dental site to a display.

Embodiment 2: The method of embodiment 1, further comprising: generating an alert to perform a corrective action responsive to detecting the one or more regions of the 3D point cloud comprising the bodily fluid.

Embodiment 3: The method of embodiment 1 or 2, further comprising: determining an amount of the bodily fluid that has been detected; determining whether the amount of the bodily fluid that has been detected exceeds a threshold; and generating an alert to perform a corrective action responsive to determining that the amount of the bodily fluid exceeds the threshold.

Embodiment 4: The method of embodiment 3, wherein the amount of bodily fluid that has been detected comprises a suspected amount of bodily fluid.

Embodiment 5: The method of embodiment 3 or embodiment 4, wherein the alert comprises a recommendation to remove the bodily fluid from the dental site prior to continuing the intraoral scanning of the dental site.

Embodiment 6: The method of any of embodiments 3-5, wherein the amount of the bodily fluid is determined based on an area covered by the one or more regions.

Embodiment 7: The method of any of embodiments 1-6, wherein the bodily fluid comprises saliva.

Embodiment 8: The method of any of embodiments 1-7, wherein the intraoral scan data further comprises one or more color two-dimensional (2D) images generated during the intraoral scanning of the dental site, and wherein detecting the one or more regions of the 3D point cloud comprising a bodily fluid comprises: detecting one or more suspected regions in the one or more color 2D images that are suspected to comprise the bodily fluid; mapping the one or more suspected regions in the one or more color 2D images to the 3D point cloud to form one or more suspected regions of the 3D point cloud that are suspected to comprise the bodily fluid; and determining one or more suspected regions of the 3D point cloud that satisfy one or more criteria, wherein the one or more suspected regions of the 3D point cloud that satisfy the one or more criteria correspond to the one or more regions of the 3D point cloud that comprise the bodily fluid.

Embodiment 9: The method of embodiment 8, wherein the one or more color 2D images were generated using unstructured white light illumination.

Embodiment 10: The method of embodiment 8 or 9, wherein detecting the one or more suspected regions in the one or more color 2D images comprises performing the following for each color 2D image of the one or more color 2D images: processing the color 2D image using a trained machine learning model, wherein the trained machine learning model outputs a segmentation mask for the color 2D image, and wherein at least one classification of the segmentation mask is a bodily fluid classification.

Embodiment 11: The method of embodiment 10, further comprising: processing the color 2D image using a second trained machine learning model, wherein the second trained machine learning model outputs a second segmentation mask for the color 2D image, and wherein at least a first classification of the second segmentation mask is a tooth classification and a second classification of the second segmentation mask is a gingiva classification.

Embodiment 12: The method of embodiment 11, wherein the trained machine learning model comprises a first neural network, wherein the second trained machine learning model comprises a second neural network, and wherein the first neural network and the second neural network share one or more layers.

Embodiment 13: The method of any of embodiments 8-12, wherein the one or more color 2D images comprise a plurality of color 2D images generated at a same point in time, each color 2D image of the plurality of color 2D images having been generated by a different camera of an intraoral scanner used to perform the intraoral scanning.

Embodiment 14: The method of any of embodiments 1-13, wherein the one or more intraoral images of the portion of the dental site generated using the structured light projection comprises a plurality of color 2D images each generated by a different camera of an intraoral scanner at a first point in time, and wherein the intraoral scan data further comprises a plurality of color two-dimensional (2D) images each generated by a different camera of the intraoral scanner, each color 2D image of the plurality of color 2D images having been generated by a same camera that generated an image of the plurality of images, the method further comprising: processing each color 2D image of the plurality of color 2D images using a trained machine learning model, wherein for each color 2D image the trained machine learning model outputs a mask that indicates, for each pixel of the color 2D image, a probability that the pixel depicts the bodily fluid; for each point in the 3D point cloud that maps to pixels in one or more color 2D images of the plurality of color 2D images, combining probabilities of the pixels in the one or more color 2D images depicting the bodily fluid to determine a probability that the point in the 3D point cloud depicts the bodily fluid; and classifying points for which the probability that the point depicts the bodily fluid exceeds a threshold as depicting the bodily fluid.

Embodiment 15: The method of embodiment 14, wherein combining the probabilities comprises determining an average of the probabilities.

Embodiment 16: The method of embodiment 14 or 15, further comprising, for each point on the 3D point cloud classified as depicting the bodily fluid, performing the following: determining a density of surrounding points that are also classified as depicting the bodily fluid; and confirming the point as depicting the bodily fluid responsive to determining that the density of the surrounding points that are also classified as depicting the bodily fluid is above a threshold.

Embodiment 17: The method of embodiment 16, wherein the density of surrounding points is determined using first additional intraoral scan data captured prior to the intraoral scan data and second additional intraoral scan data captured after the intraoral scan data was captured.

Embodiment 18: The method of embodiment 16 or 17, further comprising: estimating a shape around a group of points classified as depicting the bodily fluid; and updating points within the circular shape as depicting the bodily fluid.

Embodiment 19: The method of embodiment 18, wherein estimating the shape comprises: for each point classified as depicting the bodily fluid, determining a boundary around the point; and determining a superposition of boundaries around points.

Embodiment 20: The method of embodiment 19, wherein the boundary comprises a circular shape.

Embodiment 21: The method of any of embodiments 1-20, wherein the intraoral scan data is received at a first time, the method further comprising: receiving additional intraoral scan data of the dental site at a second time; generating a second 3D point cloud of the dental site using the additional intraoral scan data; detecting one or more second regions of the second 3D point cloud comprising the bodily fluid; determining that the one or more second regions are larger than the one or more regions; and generating an alert to perform a corrective action.

Embodiment 22: The method of any of embodiments 1-21 wherein the 3D surface comprises one or more voids corresponding to the one or more regions comprising the bodily fluid, the method further comprising: highlighting the one or more voids in the 3D surface.

Embodiment 23: The method of embodiment 22, further comprising: receiving additional intraoral scan data after the bodily fluid has been removed from the dental site; and updating the 3D surface based on the additional intraoral scan data, wherein the one or more voids are filled in based on the additional intraoral scan data.

Embodiment 24: The method of any of embodiments 1-23, wherein the bodily fluid comprises blood.

Embodiment 25: A non-transitory computer readable medium comprising instructions that, when executed by a processing device, cause the processing device to perform the method of any of embodiments 1-24.

Embodiment 26: A system comprising: a handheld scanner to perform an intraoral scan; and a non-transitory computer readable medium comprising instructions that, when executed by a processor, cause the processor to perform the method of any of embodiments 1-24.

Embodiment 27: A system comprising: a handheld scanner to perform an intraoral scan; and a computing device to perform the method of any of embodiments 1-24.

Embodiment 28: A system comprising: a handheld scanner to perform one or more operations of the method of any of embodiments 1-24 and a computing device to perform one or more remaining operations of the method of any of embodiments 1-24.

Embodiment 29: A system comprising: a handheld scanner to perform an intraoral scan; a first computing device to perform one or more operations of the method of any of embodiments 1-24 and a second computing device to perform one or more remaining operations of the method of any of embodiments 1-24.

It is to be understood that the above description is intended to be illustrative, and not restrictive. Many other embodiments will be apparent upon reading and understanding the above description. Although embodiments of the present disclosure have been described with reference to specific example embodiments, it will be recognized that the disclosure is not limited to the embodiments described, but can be practiced with modification and alteration within the spirit and scope of the appended claims. Accordingly, the specification and drawings are to be regarded in an illustrative sense rather than a restrictive sense. The scope of the disclosure should, therefore, be determined with reference to the appended claims, along with the full scope of equivalents to which such claims are entitled.

What is claimed is:

1. An intraoral scanning system, comprising:
an intraoral scanner configured to generate intraoral scan data; and
a computing device configured to:
receive intraoral scan data comprising one or more intraoral images of a portion of a dental site generated using structured light projection during intraoral scanning of the dental site;
generate a three-dimensional (3D) point cloud of the portion of the dental site using the intraoral scan data;
detect one or more regions of the 3D point cloud comprising a bodily fluid;
remove the one or more regions from the 3D point cloud;
update a 3D surface of the dental site using the 3D point cloud of the portion of the dental site; and
output the 3D surface of the dental site to a display.

2. The intraoral scanning system of claim 1, wherein at least one of the intraoral scanner or the computing device is configured to:
generate an alert to perform a corrective action responsive to detection of the one or more regions of the 3D point cloud comprising the bodily fluid.

3. The intraoral scanning system of claim 1, wherein the computing device is further configured to:
determine an amount of the bodily fluid that has been detected;
determine whether the amount of the bodily fluid that has been detected exceeds a threshold; and
generate an alert to perform a corrective action responsive to determining that the amount of the bodily fluid exceeds the threshold.

4. The intraoral scanning system of claim 3, wherein the amount of bodily fluid that has been detected comprises a suspected amount of bodily fluid.

5. The intraoral scanning system of claim 3, wherein the alert comprises a recommendation to remove the bodily fluid from the dental site prior to continuing the intraoral scanning of the dental site.

6. The intraoral scanning system of claim 3, wherein the amount of the bodily fluid is determined based on an area covered by the one or more regions.

7. The intraoral scanning system of claim 1, wherein the intraoral scan data further comprises one or more color two-dimensional (2D) images generated during the intraoral scanning of the dental site, and wherein detecting the one or more regions of the 3D point cloud comprising a bodily fluid comprises:
detecting one or more suspected regions in the one or more color 2D images that are suspected to comprise the bodily fluid;
mapping the one or more suspected regions in the one or more color 2D images to the 3D point cloud to form one or more suspected regions of the 3D point cloud that are suspected to comprise the bodily fluid; and
determining one or more suspected regions of the 3D point cloud that satisfy one or more criteria, wherein the one or more suspected regions of the 3D point cloud that satisfy the one or more criteria correspond to the one or more regions of the 3D point cloud that comprise the bodily fluid.

8. The intraoral scanning system of claim 7, wherein the one or more color 2D images were generated using unstructured white light illumination.

9. The intraoral scanning system of claim 7, wherein detecting the one or more suspected regions in the one or more color 2D images comprises performing the following for each color 2D image of the one or more color 2D images:
processing the color 2D image using a trained machine learning model, wherein the trained machine learning model outputs a segmentation mask for the color 2D image, and wherein at least one classification of the segmentation mask is a bodily fluid classification.

10. The intraoral scanning system of claim 9, wherein the computing device is further configured to:
process the color 2D image using a second trained machine learning model, wherein the second trained machine learning model outputs a second segmentation mask for the color 2D image, and wherein at least a first classification of the second segmentation mask is a tooth classification and a second classification of the second segmentation mask is a gingiva classification.

11. The intraoral scanning system of claim 10, wherein the trained machine learning model comprises a first neural network, wherein the second trained machine learning model comprises a second neural network, and wherein the first neural network and the second neural network share one or more layers.

12. The intraoral scanning system of claim 7, wherein the one or more color 2D images comprise a plurality of color 2D images generated at a same point in time, each color 2D image of the plurality of color 2D images having been generated by a different camera of an intraoral scanner used to perform the intraoral scanning.

13. The intraoral scanning system of claim 1, wherein the one or more intraoral images of the portion of the dental site generated using the structured light projection comprises a plurality of color 2D images each generated by a different camera of an intraoral scanner at a first point in time, wherein the intraoral scan data further comprises a plurality of color two-dimensional (2D) images each generated by a different camera of the intraoral scanner, each color 2D image of the plurality of color 2D images having been generated by a same camera that generated an image of the plurality of color 2D images, and wherein the computing device is further configured to:
process each color 2D image of the plurality of color 2D images using a trained machine learning model, wherein for each color 2D image the trained machine learning model outputs a mask that indicates, for each pixel of the color 2D image, a probability that the pixel depicts the bodily fluid;
for each point in the 3D point cloud that maps to pixels in one or more color 2D images of the plurality of color 2D images, combine probabilities of the pixels in the one or more color 2D images depicting the bodily fluid to determine a probability that the point in the 3D point cloud depicts the bodily fluid; and
classify points for which the probability that the point depicts the bodily fluid exceeds a threshold as depicting the bodily fluid.

14. The intraoral scanning system of claim 13, wherein the computing device is further configured to, for each point on the 3D point cloud classified as depicting the bodily fluid, perform the following:
determine a density of surrounding points that are also classified as depicting the bodily fluid; and
confirm the point as depicting the bodily fluid responsive to determining that the density of the surrounding points that are also classified as depicting the bodily fluid is above a threshold.

15. The intraoral scanning system of claim 14, wherein the density of surrounding points is determined using first additional intraoral scan data captured prior to the intraoral scan data and second additional intraoral scan data captured after the intraoral scan data was captured.

16. The intraoral scanning system of claim 14, wherein the computing device is further configured to:
estimate a circular shape around a group of points classified as depicting the bodily fluid; and
update points within the circular shape as depicting the bodily fluid.

17. The intraoral scanning system of claim 16, wherein estimating the shape comprises:
for each point classified as depicting the bodily fluid, determining a boundary around the point; and
determining a superposition of boundaries around points.

18. The intraoral scanning system of claim 1, wherein the intraoral scan data is received at a first time, and wherein the computing device is further configured to:
receive additional intraoral scan data of the dental site at a second time;
generate a second 3D point cloud of the dental site using the additional intraoral scan data;
detect one or more second regions of the second 3D point cloud comprising the bodily fluid;
determine that the one or more second regions are larger than the one or more regions; and
generate an alert to perform a corrective action.

19. The intraoral scanning system of claim 1, wherein the 3D surface comprises one or more voids corresponding to the one or more regions comprising the bodily fluid, and wherein the computing device is further configured to:
highlight the one or more voids in the 3D surface.

20. The intraoral scanning system of claim 19, wherein the computing device is further configured to:
receive additional intraoral scan data after the bodily fluid has been removed from the dental site; and
update the 3D surface based on the additional intraoral scan data, wherein the one or more voids are filled in based on the additional intraoral scan data.

21. An intraoral scanning system, comprising:
an intraoral scanner configured to generate intraoral scan data; and
a first computing device configured to:
receive intraoral scan data comprising one or more intraoral images of a portion of a dental site generated using structured light projection during intraoral scanning of the dental site;
generate a three-dimensional (3D) point cloud of the portion of the dental site using the intraoral scan data; and
transmit the 3D point cloud to a second computing device; and
the second computing device, configured to:
detect one or more regions of the 3D point cloud comprising a bodily fluid;
remove the one or more regions from the 3D point cloud;
update a 3D surface of the dental site using the 3D point cloud of the portion of the dental site; and
transmit the 3D surface of the dental site to the first computing device.

22. An intraoral scanner, comprising:
a plurality of structured light projectors to generate a structured light pattern;
a plurality of cameras to capture a plurality of images of a portion of a dental site illuminated by the structured light pattern; and
a processor configured to:
generate a three-dimensional (3D) point cloud of the portion of the dental site using at least some of the plurality of images;
detect one or more regions of the 3D point cloud comprising a bodily fluid;
remove the one or more regions from the 3D point cloud; and
transmit the 3D point cloud to a computing device for further processing.
